(19) United States
(12) Patent Application Publication
(10) Pub. No.: US 2023/0110621 A1
(43) Pub. Date: Apr. 13, 2023

(54) ENVIRONMENTALLY FRIENDLY CONSTRUCTION MATERIAL COMPOSITIONS HAVING IMPROVED EARLY STRENGTH

(71) Applicant: BASF SE, Ludwigshafen am Rhein (DE)

(72) Inventors: Xuerun LI, Trostberg (DE); Christoph HESSE, Trostberg (DE); Bernhard MAYR, Trostberg (DE); Julien BIZZOZERO, Trostberg (DE)

(21) Appl. No.: 17/911,438

(22) PCT Filed: Mar. 15, 2021
(86) PCT No.: PCT/EP2021/056449

§ 371 Date: Sep. 14, 2022

(30) Foreign Application Priority Data
Mar. 20, 2020 (EP) 20164724.5

(51) Int. Cl. C04B 28/04; C04B 28/16; C04B 22/00; C04B 7/02; C04B 14/28

(52) U.S. Cl. CPC C04B 28/04; C04B 28/16; C04B 22/00863; C04B 7/02; C04B 14/28; C04B 2103/14

(57) ABSTRACT

The present invention relates to construction material compositions comprising at most 55% by dry weight of Portland cement with a high early and late compressive strength. The other main components in the cement are SCMs, limestone, sulfate source and accelerator.

The present invention relates to a construction material composition comprising Portland cement clinker, a supplementary cementitious material, a calcium carbonate phase, a sulfate source, and a hardening accelerator A. The content of the Portland cement clinker is (greatly) reduced compared to classic ordinary cement.

Cementitious systems are more often under observation in view of environmental aspects due to CO₂ emission. The trend in the cement industry to cope with the CO₂ emission is to use more SCMs (supplementary materials, typically slag, fly ash, and recently newly developed calcined clays) in the ordinary Portland cement (OPC) (Scrivener et al., Cement and Concrete Research, 114, 2018).

The general draw back of the use of high amount of SCMs in the cement is the relatively low early strength. In systems incorporated with calcined clay and limestone (so called LC³ cement, using ˜50% of OPC), the performance of the cement is comparable with the OPC in many aspects such as long-term strength (Antoni et al., Cement and Concrete Research, 42, 2012) and durability (Scrivener et al., Advances in Civil Engineering Materials, 8, 2019). However, the early strength is relatively low compared to the OPC due to the reduced amount of the C₃S coming from the OPC which contributes to the early strength.

WO2010026155 relates to a seeding technology (C—S—H seeding) in order to enhance the reaction of tricalcium silicate (also known as 3 CaO.SiO₂ or C₃S) during the early ages thus improving the early strength (Thomas et al., The Journal of Physical Chemistry C, 113, 2009). The technology was proved to be working and recent products such as XSeed® were found to be effective.

In WO 2015150473 a cement comprising OPC, limestone, calcium sulfate, and C—S—H is disclosed. The strength after 28 days is however not satisfactory.

Hence, there is the ongoing need for an improved environmentally friendly construction material composition. Against this background, it was an object of the present invention to provide a construction material composition with improved mechanical properties regarding early and/or late strength compared to ordinary Portland cement according to the norm EN 197-1:2011 with similar Portland cement clinker amount. In particular, it was an object of the present invention to provide a construction material composition having a reduced amount of Portland cement clinker, which provides a comparable early and/or late strength compared to OPC with higher amount of Portland cement clinker. Further it was an object of the present invention to provide a construction material composition, which provides higher early and/or late strength at approximately same clinker content in cement class CEM III, CEM IV and CEM V according to EN 197-1:2011. Further, it was an object of the present invention to provide a mortar comprising a construction material composition having a reduced amount of Portland cement clinker but still providing a comparable or even improved early and/or late strength compared to the normal Portland cement content. Further, it was an object of the present invention to provide a construction material composition having only ingredients which are non-hazardous according to the global harmonized system (GHS) with the focus to avoid components categorized with GHS08 (Serious health hazard) or GHS06 (acute toxicity). Finally, it was an object of the present invention to provide a process for producing a construction material composition having a reduced amount of Portland cement clinker but still providing a comparable or even improved early and/or late strength.

It has surprisingly been found that at least one of these objects can be achieved by the construction material composition as claimed. It has been found that the construction material composition as defined hereinafter provides improved mechanical properties regarding early and/or late strength compared to ordinary Portland cement according to the norm EN 197-1:2011 at similar Portland cement clinker amount and where the amount of Portland cement clinker in the OPC is lower than 55 wt.-%.

In a first aspect, the present invention therefore relates to a construction material composition comprising
a) Portland cement clinker in an amount of from 15 to 55% by dry weight based on the total dry weight of the construction material composition;
b) a supplementary cementitious material in an amount of from 20 to 75% by dry weight based on the total dry weight of the construction material composition;
c) a calcium carbonate phase in an amount of from 5 to 40% by dry weight based on the total dry weight of the construction material composition;
d) a sulfate source selected from the group consisting of gypsum, bassanite, anhydrite, and mixtures thereof in an amount of from more than 2.2 to 8 wt.-% of SO₃ based on the total dry weight of the construction material composition; and
e) a hardening accelerator A comprising particles with calcium and silicon in a molar ratio Ca/Si of 0.1 to 2.2 in an amount of from 0.1 to 5% by weight related to the weight of the sum of CaO and SiO₂ of the hardening accelerator A based on the total dry weight of the construction material composition.

In the following, preferred embodiments of the components of the construction material composition are described in further detail. It is to be understood that each preferred embodiment is relevant on its own as well as in combination with other preferred embodiments.

In a preferred embodiment Al of the first aspect, the supplementary cementitious material is selected from the group consisting of slag, fly ash, natural pozzolans, calcinated clay, silica fume, and mixtures thereof.

In a preferred embodiment A2 of the first aspect, the calcium carbonate phase is selected from limestone, dolomite, calcite, aragonite, vaterite, and mixtures thereof.

In a preferred embodiment A3 of the first aspect, the total SO₃ content and the total Al₂O₃ content determined by elemental analysis are present in a weight ratio of from 1:10 to 5:1.

In a preferred embodiment A4 of the first aspect, the Portland cement clinker and the supplementary cementitious material are present in a weight ratio of from 2:1 to 1:5.

In a preferred embodiment A5 of the first aspect, the Portland cement clinker and the limestone are present in a weight ratio of from 4:1 to 1:2.

In a preferred embodiment A6 of the first aspect, the hardening accelerator A further comprises a water soluble polymer in an amount of from 0.1% to 50% by weight related to the dry weight of the hardening accelerator A.

In a preferred embodiment A7 of the first aspect, the hardening accelerator A comprises particles which are calcium-silicate-hydrate of the following empirical formula

aCaO, SiO₂, b Al₂O₃, c H₂O, d X, e W

X is an alkali metal
W is an alkaline earth metal

| | | |
|---|---|---|
| 0.5 ≤ a ≤ 2.5 | preferably | 0.66 ≤ a ≤ 2.0 |
| 0 ≤ b ≤ 1 | preferably | 0 ≤ b ≤ 0.1 |
| 1 ≤ c ≤ 6 | preferably | 1 ≤ c ≤ 6.0 |
| 0 ≤ d ≤ 1 | preferably | 0 ≤ d ≤ 0.4 or 0.2 |
| 0 ≤ e ≤ 2 | preferably | 0 ≤ e ≤ 0.1. |

In a preferred embodiment A8 of the first aspect, the construction material composition comprises
a) the Portland cement clinker in an amount of from 40 to 55% by dry weight based on the total dry weight of the construction material composition;
b) the supplementary cementitious material in an amount of from 30 to 45% by dry weight based on the total dry weight of the construction material composition;
c) the calcium carbonate phase in an amount of from 15 to 30% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.1 to 5% by weight related to the weight of the sum of CaO and SiO₂ of the hardening accelerator A based on the total dry weight of the construction material composition.
   In a preferred embodiment A9 of the first aspect, the construction material composition comprises
a) the Portland cement clinker in an amount of from 30 to 40% by dry weight based on the total dry weight of the construction material composition;
b) the supplementary cementitious material in an amount of from 30 to 45% by dry weight based on the total dry weight of the construction material composition;
c) the calcium carbonate phase in an amount of from 20 to 30% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.5 to 5% by weight related to the weight of the sum of CaO and SiO₂ of the hardening accelerator A based on the total dry weight of the construction material composition.
   In a preferred embodiment A10 of the first aspect, the construction material composition comprises
a) Portland cement clinker in an amount of from 20 to 30% by dry weight based on the total dry weight of the construction material composition;
b) the supplementary cementitious material in an amount of from 30 to 50% by dry weight based on the total dry weight of the construction material composition;
c) the calcium carbonate phase in an amount of from 20 to 40% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 1.0 to 5% by weight related to the weight of the sum of CaO and SiO₂ of the hardening accelerator A based on the total dry weight of the construction material composition.
   In a preferred embodiment A11 of the first aspect, the construction material composition comprises from more than 30 to 75% by dry weight of the supplementary cementitious material, based on the total dry weight of the construction material composition.
   In a preferred embodiment A12 of the first aspect, the construction material composition comprises
a) the Portland cement clinker in an amount of from 15 to 47% by dry weight based on the total dry weight of the construction material composition;
b) the supplementary cementitious material in an amount of from more than 30 to 70% by dry weight based on the total dry weight of the construction material composition;
c) the calcium carbonate phase in an amount of from 5 to 20% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.1 to 5% by weight related to the weight of the sum of CaO and SiO₂ of the hardening accelerator A based on the total dry weight of the construction material composition, preferably wherein the supplementary cementitious material comprises at least two different supplementary cementitious materials.

In a preferred embodiment A13 of the first aspect, the construction material composition additionally comprises at least one additive, wherein preferably the at least one additive is selected from the group consisting of inorganic carbonates, alkali metal sulfates, polymeric dispersants, hardening accelerators, hardening retarders, thickeners, and stabilizers or a mixture of two or more thereof.

In a preferred embodiment A14 of the first aspect, the construction material composition additionally comprised at least one polymeric dispersant, in particular a polycarboxylate ether, phosphorylated polycondensation product or a sulfonic acid and/or sulfonate group containing dispersant.

In a preferred embodiment A15 of the first aspect, the construction material composition additionally comprises at least one polymeric dispersant, which is a sulfonic acid and/or sulfonate group containing dispersant selected from the group consisting of lignosulfonates, melamine formaldehyde sulfonate condensates, beta-naphthalene sulfonic acid condensates, sulfonated ketone-formaldehyde-condensates, and copolymers comprising sulfo group containing units and/or sulfonate group-containing units and carboxylic acid and/or carboxylate group-containing units.

In a preferred embodiment A16 of the first aspect, the construction material composition additionally comprises at least one hardening accelerator B.

In a second aspect, the present invention relates to the use of a hardening accelerator A comprising particles with calcium and silicon in a molar ratio Ca/Si of 0.1 to 2.2 in a construction material composition comprising at most 55% by dry weight of Portland cement clinker based on the total dry weight of the construction material composition, wherein the hardening accelerator A is present in the construction material composition in an amount of from 0.1 to 5% by weight related to the weight of the sum of CaO and SiO₂ of the hardening accelerator A based on the total dry weight of the construction material composition.

In a preferred embodiment B1 of the second aspect, the construction material composition is as claimed.

In a third aspect, the present invention relates to a mortar or concrete comprising a construction material composition as claimed.

In a fourth aspect, the present invention relates to a process for producing a construction material composition as claimed, wherein the calcium carbonate phase is provided as a powder and the hardening accelerator A is provided as a suspension.

In a fifth aspect, the present invention relates to a process for producing a construction material composition as claimed, wherein the addition of hardening accelerator A is done during or after blending components a) to d).

### DETAILED DESCRIPTION

Before describing in detail exemplary embodiments of the present invention, definitions important for understanding the present invention are given.

As used in this specification and in the appended claims, the singular forms of “a” and “an” also include the respective plurals unless the context clearly dictates otherwise. In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%. It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “ii” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art. The terms “early strength” and “late strength” are interchangeable with “early compressive strength” and “late compressive strength”, respectively.

Preferred embodiments regarding the construction material compositions and the use thereof are described in detail hereinafter. It is to be understood that the preferred embodiments of the invention are preferred alone or in combination with each other.

As indicated above, the present invention relates in one embodiment to a construction material composition comprising
a) Portland cement clinker in an amount of from 15 to 55% by dry weight based on the total dry weight of the construction material composition;
b) a supplementary cementitious material in an amount of from 20 to 75% by dry weight based on the total dry weight of the construction material composition;
c) a calcium carbonate phase in an amount of from 5 to 40% by dry weight based on the total dry weight of the construction material composition;
d) a sulfate source selected from the group consisting of gypsum, bassanite, anhydrite, and mixtures thereof in an amount of from more than 2.2 to 8 wt.-% of SO₃ based on the total dry weight of the construction material composition; and
e) a hardening accelerator A comprising particles with calcium and silicon in a molar ratio Ca/Si of 0.1 to 2.2 in an amount of from 0.1 to 5% by weight related to the weight of the sum of CaO and SiO₂ of the hardening accelerator A based on the total dry weight of the construction material composition.

When referred to compositions and the weight percent of the therein comprised ingredients it is to be understood that according to the present invention the overall amount of ingredients does not exceed 100% (±1% due to rounding).

It is further to be understood that according to the present invention the term “Portland cement clinker” refers to the sum of clinker phases without any calcium sulfate phase. Portland cement clinker phases are including elite (C₃S), belite (C₂S), brownmillerite (C₄AF), or C3A and mixtures thereof.

In a preferred embodiment the Portland cement clinker comprises mainly belite in an amount of more than 40 wt.-%, based on the total weight of the Portland cement clinker.

In one embodiment of the present invention, the Portland cement clinker according to component a) of the construction material composition is selected from clinker-bearing materials comprising at least 65 wt.-%, preferred 80 wt.-%, more preferred 95 wt.-% of Portland cement clinker based on the total weight of the used clinker-bearing material. In another preferred embodiment of the present invention, the Portland cement clinker according to component a) of the construction material composition is selected from clinker-bearing materials comprising at least 65 wt.-%, preferred at least 80 wt.-%, more preferred at least 90 wt.-%, and in particular at least 95 wt.-% of Portland cement clinker based on the total weight of the used clinker-bearing material. The clinker bearing material is ordinary Portland cement (OPC) according to DIN EN 197-1:2011-11. Preferred OPC's according to the norm are CEM I 42.5 N, CEM I 42.5 R, CEM I 52.5 N, and CEM I 52.5 R or mixtures thereof with an amount of at least 95 wt.-% of Portland cement clinker.

In one embodiment of the present invention, the construction material composition comprises the Portland cement clinker in an amount of from 15 to 55% by dry weight, preferably from 20 to 55% by dry weight or from 15 to 40% by dry weight, more preferably from 15 to 47% by dry weight, or from 25 to 50% by dry weight, or from 40 to 55% by dry weight, or from 30 to 40% by dry weight, or from 20 to 30% by dry weight, based on the total dry weight of the construction material composition.

According to a preferred embodiment of the present invention, the construction material composition comprises less than 40% by dry weight, preferably less than 35% by dry weight, more preferably less than 30% by dry weight, and in particular less than 25% by dry weight, of components, which are declared hazardous according to GHS08, based on the total % by dry weight of the construction material composition. It is further preferred that the construction material composition comprises from 0 to less than 40% by dry weight, preferably from 0 to less than 35% by dry weight, more preferably from 0 to less than 30% by dry weight, and in particular from 0 to less than 25% by dry weight, of components, which are declared hazardous according to GHS08, based on the total % by dry weight of the construction material composition.

In this connection it is particularly preferred that the construction material composition comprises less than 40% by dry weight, preferably less than 35% by dry weight, more preferably less than 30% by dry weight, and in particular less than 25% by dry weight, of fine quartz (also known as quartz powder), based on the total % by dry weight of the construction material composition. It is further preferred that the construction material composition comprises from 0 to less than 40% by dry weight, preferably from 0 to less than 35% by dry weight, more preferably from 0 to less than 30% by dry weight, and in particular from 0 to less than 25% by dry weight, of fine quartz, based on the total % by dry weight of the construction material composition.

The term “fine quartz” according to the present invention refers to fine quartz with a maximum grain size of at most 63 μm.

The construction material composition comprises the supplementary cementitious material in an amount of from 20 to 75% by dry weight, preferably from 20 to 55% by dry weight, more preferably from 25 to 45% by dry weight, and still more preferably from 30 to 45% by dry weight, based on the total dry weight of the construction material composition.

In another preferred embodiment of the present invention, the construction material composition comprises the supplementary cementitious material from more than 30 to 75% by dry weight, preferably from 35 to 72% by dry weight, more preferably from 45 to 71% by dry weight, still more preferably from 55 to 71% by dry weight, and in particular from 65 to 70% by dry weight, based on the total dry weight of the construction material composition.

The supplementary cementitious material may be any suitable cementitious material. In one embodiment of the present invention, the supplementary cementitious material is selected from the group consisting of slag, fly ash, natural pozzolans, calcinated clay, silica fume, and mixtures thereof.

Preferably, if the supplementary cementitious material is comprised in the construction material composition from more than 30 to 75% by dry weight, preferably from 35 to 72% by dry weight, more preferably from 45 to 71% by dry weight, still more preferably from 55 to 71% by dry weight, and in particular from 65 to 70% by dry weight, based on the total dry weight of the construction material composition, at least two different supplementary cementitious material are comprised. In this connection, it is preferred that the supplementary cementitious material comprises slag and a different supplementary cementitious material selected from the group consisting of fly ash, natural pozzolans, calcinated clay, silica fume, and mixtures thereof. It is also preferred that the supplementary cementitious material comprises calcinated clay and a different supplementary cementitious material selected from the group consisting of slag, fly ash, natural pozzolans, silica fume, and mixtures thereof. Preferably, the supplementary cementitious material comprises calcinated clay and slag.

If at least two supplementary cementitious materials (i.e. SCM1 and SCM2) are comprised in the supplementary cementitious material SCM1 and SCM2 have preferably a weight ratio of 3:1 to 1:3, more preferably of 2:1 to 1:2, still more preferably of 1.5:1 to 1:1.5, and in particular of 1.2:1 to 1:1.2.

The slag can be either industrial slag, i.e. waste products from industrial processes, or else synthetic slag. The latter can be advantageous because industrial slag is not always available in consistent quantity and quality. Blast furnace slag, electrothermal phosphorous slag, steel slag and mixtures thereof may be named.

Blast furnace slag (BFS) is a waste product of iron and steel-making process. Other materials are granulated blast furnace slag (GBFS) and ground granulated blast furnace slag (GGBFS), which is granulated blast furnace slag that has been finely pulverized. Ground granulated blast furnace slag varies in terms of grinding fineness and grain size distribution, which depend on origin and treatment method, and grinding fineness influences reactivity here. The Blaine value is used as parameter for grinding fineness, and typically has an order of magnitude of from 200 to 1000 m² kg⁻², preferably from 300 to 600 m² kg ⁻¹. Finer milling gives higher reactivity.

For the purposes of the present invention, the expression “blast furnace slag” is however intended to comprise materials resulting from all of the levels of treatment, milling, and quality mentioned (i.e. BFS, GBFS and GGBFS). Blast furnace slag generally comprises from 30 to 45% by weight of CaO, about 4 to 17% by weight of MgO, about 30 to 45% by weight of SiO₂ and about 5 to 15% by weight of Al₂O₃, typically about 40% by weight of CaO, about 10% by weight of MgO, about 35% by weight of SiO₂ and about 12% by weight of Al₂O₃.

Electrothermal phosphorous slag is a waste product of electrothermal phosphorous production. It is less reactive than blast furnace slag and comprises about 45 to 50% by weight of CaO, about 0.5 to 3% by weight of MgO, about 38 to 43% by weight of SiO₂, about 2 to 5% by weight of Al₂O₃ and about 0.2 to 3% by weight of Fe₂O₃, and also fluoride and phosphate. Steel slag is a waste product of various steel production processes with greatly varying composition.

The fly ash can be brown-coal fly ash and hard-coal fly ash. Fly ash is produced inter alia during the combustion of coal in power stations. Class C fly ash (brown-coal fly ash) comprises according to WO 08/012438 about 10% by weight of CaO, whereas class F fly ash (hard-coal fly ash) comprises less than 8% by weight, preferably less than 4% by weight, and typically about 2% by weight of CaO.

The natural pozzolans may be selected from tuff, trass, and volcanic ash, natural and synthetic zeolites and mixtures thereof.

Clay is the common name for a number of fine-grained, earthy materials that become plastic when wet and are mostly composed of phyllosilicate minerals containing variable amounts of water trapped in the mineral structure. There are many types of known clay minerals. Some of the more common types are: kaolinite, illite, chlorite, vermiculite and smectite, also known as montmorillonite, the latter two have pronounced ability to adsorb water.

Chemically, clays are hydrous aluminum silicates, usually containing alkaline metals, alkaline earth metals and/or iron. The clay mineral consists of sheets of interconnected silicates combined with a second sheet-like grouping of metallic atoms, oxygen, and hydroxyl, forming a two layer mineral as in kaolinite. Sometimes the latter sheet like structure is found sandwiched between two silica sheets, forming a three-layer mineral such as in vermiculite. Structurally, the clay minerals are composed of planes of cations, arranged in sheets, which may be tetrahedral or octahedral coordinated (with oxygen), which in turn are arranged into layers often described as 2:1 if they involve units composed of two tetrahedral and one octahedral sheet or 1:1 if they involve units of alternating tetrahedral and octahedral sheets. Additionally some 2:1 clay minerals have interlayer sites between successive 2:1 units which may be occupied by interlayer cations that are often hydrated. Clay minerals are divided by layer type, and within layer type, by groups based on charge x per formula unit (Guggenheim S. et al., Clays and Clay Minerals, 54 (6), 761-772, 2006). The charge per formula unit, x, is the net negative charge per layer, expressed as a positive number. Further subdivisions by subgroups are based on dioctahedral or trioctahedral character, and finally by species based on chemical composition e.g.
x≈0: pyrophyllite-group
x≈0.2-0.6: smectite-group e.g. montmorillonite, nontronite, saponite or hectorite
x≈0.6-0.9: vermiculite-group
x≈1.8-2: brittle mica-group e.g. clintonite, anandite, kinoshitalite.

In one embodiment, the supplementary cementitious material is calcinated clay (also referred to as calcined clay). Calcination as used herein refers to heating to high temperatures in air or oxygen. The heat treated clay material is calcined clay produced at a temperature of between 500° C. and 900° C. According to another embodiment of the present invention the heat treated clay material is calcined clay produced at a temperature of between 500° C. and 750° C. According to another embodiment of the present invention the heat treated clay material is produced by heat treating the clay material separately from the other constituents of the supplementary cementitious material at a temperature sufficient to a) dehydroxylate the clay material to a crystallographically amorphous material, and b) prevent the formation of high temperature alumino-silicate phases such as mullite. It was found that it is preferable to use clay that has been calcined by heat treating the clay at a temperature sufficient to a) dehydroxylate the clay to a crystallographically amorphous material, and b) prevent the formation of crystalline high temperature aluminosilicate phases such as mullite. The temperature at which these requirements are met may vary between clay materials but is between 500 and 750° C. when the clay is heat treated before mixing with the limestone.

Metakaolin may be named as a calcinated clay. Metakaolin is produced when kaolin is dehydrated. Whereas at from 100 to 200° C. kaolin releases physically bound water, at from 500 to 800° C. a dehydroxylation takes place, with collapse of the lattice structure and formation of metakaolin (Al₂Si₂O₇). Accordingly, pure metakaolin comprises about 54% by weight of SiO₂ and about 46% by weight of Al₂O₃.

Fumed silica (i.e. silica fume) is produced via reaction of chlorosilanes, for example silicon tetrachloride, in a hydrogen/oxygen flame. Fumed silica is an amorphous SiO₂ powder of particle diameter from 5 to 50 nm with specific surface area of from 50 to 600 m₂ g⁻¹.

Typical SCMs are made of amorphous content and some crystalline phases mineralogically (detected by XRD). The reactive part is mostly coming from the amorphous content. Chemically, SCMs are mainly made of Al₂O₃, SiO₂, CaO, and alkali (Na₂O or/and K₂O). In this connection, reactivity refers to the nature of the material reacting with H₂O alone or together with Ca(OH)₂ in the system producing heat and strength. Specific characteristics are listed in the table (Reactivity based on calorimetry as per Ref: Li, X., et al. (2018). “Reactivity tests for supplementary cementitious materials: RILEM TC 267-TRM phase 1.” Materials and Structures 51(6): 151) below:

| | | | | | | | | R3 Reactivity |
|---|---|---|---|---|---|---|---|---|
| | | | | | | | | based on |
| | | | | | | Particle | Blaine | calorimetry |
| | XRD | | | | | size | (cm²/g) | g/100 g |
| | amorph. | | | | Stand. | Dᵥ50 | as per | SCMs as |
| Types | % | CaO | SiO2 | Al2O3 | ref. | (μm) | EN196 | per Ref |
| Calcined | 40-90 | 0-10 | 40-80 | 15-50 | | 5-20 | 3000-15000 | 300-1000 |
| clay | | | | | | | | |
| Ground- | 70-98 | 30-50 | 30-50 | 5-20 | | 10-20 | 2000-6000 | 200-700 |
| granulated | | | | | | | | |
| blast- | | | | | | | | |
| furnace | | | | | | | | |
| slag | | | | | | | | |
| Fly ash | 25-80 | 10-50 | 5-60 | 0-30 | EN | 5-20 | 2000-6000 | 200-500 |
| (class C) | | | | | 450-1 | | | |
| Fly ash | 50-95 | 0-5 | 40-80 | 15-40 | EN | 5-20 | 2000-6000 | 100-300 |
| (class F) | | | | | 450-1 | | | |
| Natural | 5-90 | 0-20 | 40-80 | 10-30 | ASTM | 5-30 | | 100-300 |
| Pozzolans | | | | | C618 | | | |
| Silica fume | 80-100 | | | | | 0.1-2 | | 200-600 |
| municipal | 25-80 | | | | | 2-20 | | 100-300 |
| solid waste | | | | | | | | |
| incineration | | | | | | | | |
| fly | | | | | | | | |
| ash | | | | | | | | |
| Other types | 50-98 | | | | | 5-20 | | 200-700 |
| of slags: | | | | | | | | |
| copper | | | | | | | | |
| slag, zinc | | | | | | | | |
| slag, | | | | | | | | |
| aluminum | | | | | | | | |
| slag | | | | | | | | |
| Other types | 5-90 | | | | | 2-20 | | 100-500 |
| of ashes: | | | | | | | | |
| Bio-mass | | | | | | | | |
| fly ash, rice | | | | | | | | |
| husk ash, | | | | | | | | |
| Municipal | | | | | | | | |
| solid waste | | | | | | | | |
| ash, | | | | | | | | |
| bottom ash | | | | | | | | |
| Ground | 70-100 | | | | | 5-20 | | 100-300 |
| glass | | | | | | | | |
| Limestone | <10 | 50-64 | | | | 1-40 | | |

The construction material composition comprises the calcium carbonate phase in an amount of from 5 to 40% by dry weight, preferably from 10 to 40% by dry weight, or from 10 to 20% by dry weight, or from 20 to 30% by dry weight, or from 30 to 40% by dry weight, and preferably from 15 to 30% by dry weight, based on the total dry weight of the construction material composition. In another preferred embodiment of the invention, the construction material composition comprises the calcium carbonate phase in an amount of from 5 to 35% by dry weight, preferably from 5 to 20% by dry weight, more preferably from 5 to 10% by dry weight or from 6 to 17% by dry weight, based on the total dry weight of the construction material composition.

The calcium carbonate phase may be any suitable calcium carbonate comprising phase. As used herein, the term “calcium carbonate phase” refers to a solid material composed from at least 75% by weight, preferably from at least 80% by weight, more preferably from at least 85% by weight, and in particular from at least 90% by weight, of carbonate minerals such as the minerals calcite (CaCO₃), aragonite (CaCO₃) or vaterite (CaCO₃) or dolomite (CaMg(CO₃)₂).

In one embodiment of the present invention, the calcium carbonate phase is selected from the group consisting of limestone, dolomite, chalk, and mixtures thereof.

In a preferred embodiment of the present invention, the calcium carbonate phase is selected from the group consisting of limestone, dolomite, and mixtures thereof, and in particular the calcium carbonate phase is limestone.

The calcium carbonate phase may be provided as a powder.

The construction material composition comprises the sulfate source in an amount of from more than 2.2 to 8 wt.-% of SO₃, preferably from 2.5 to 7 wt.-% of SO₃, based on the total dry weight of the construction material composition. The sulfate source according to the present invention is selected from the group consisting of gypsum, bassanite, anhydrite, and mixtures thereof.

It is to be understood that the sulfate source according to the present invention refers to an additional added sulfate source and not to calcium sulfate which is comprised in OPC. Hence, the construction material composition according to the present invention does necessarily comprise a supplementary added sulfate source.

In general, gypsum rock is mined or quarried and transported to the manufacturing facility. The manufacturer receives quarried gypsum and crushes the large pieces before any further processing takes place. Crushed rock is then ground into a fine powder and heated to about 120-160 degrees C., driving off three-fourths of the chemically bound water in a process called “calcining”, providing “calcined gypsum”. Further heating of gypsum, slightly beyond 200° C. produces anhydrite gypsum (CaSO₄) that when mixed with water, sets very slowly. The calcined gypsum (hemihydrate or anhydrite) CaSO₄.½H₂O or CaSO₄ are then used as the base for gypsum plaster, plaster of paris, gypsum board and other gypsum products. Products of the various calcinating procedures are alpha and beta-hemihydrate. Beta calcium sulfate hemihydrate results from rapid heating in open units with rapid evaporation of water forming cavities in the resulting anhydrous product. Alpha-hemihydrate is obtained by dehydrating gypsum in closed autoclaves. The crystals formed in this case are dense and therefore the resulting inorganic binder requires less water for rehydrating compared to beta-hemihydrate.

The typical natural gypsum sources that are commercially available often contain clay mineral and other impurities of up to 20% or more that results in reduced calcium sulfate levels.

The construction material composition comprises a hardening accelerator A comprising particles with calcium and silicon in a molar ratio Ca/Si of 0.1 to 2.2 in an amount of from 0.1 to 5% by weight related to the weight of the sum of CaO and SiO₂ of the hardening accelerator A based on the total dry weight of the construction material composition.

In one embodiment of the present invention, the hardening accelerator A is comprised in an amount of from 0.1 to 5%, or from 0.5 to 5%, or from 1.0 to 5.0%, by weight related to the weight of the sum of CaO and SiO₂ of the hardening accelerator A based on the total dry weight of the construction material composition.

According to the present invention, the hardening accelerator A comprises particles with calcium and silicon in a molar ratio Ca/Si of 0.1 to 2.2, preferably of 0.5 to 2.2, and in particular from 1.5 to 2.2. In one embodiment of the present invention, the hardening accelerator A comprises particles with calcium and silicon in a molar ratio Ca/Si of 0.6 to 1.5 or from 1.5 to 2.2.

In one embodiment of the present invention, the hardening accelerator A comprises the particles with calcium and silicon in a molar ratio Ca/Si of 0.1 to 2.2 in an amount of from 20 to 99.9%, preferably from 30 to 99.5%, more preferred from 40 to 90%, and in particular from 45 to 85% by weight related to the dry weight of the hardening accelerator A.

It is to be understood that the particles with calcium and silicon in a molar ratio Ca/Si 0.1 to 2.2 according to the present invention do not contain calcium salts selected from the group consisting of calcium chloride, calcium nitrate, calcium formate, calcium acetate, calcium bicarbonate, calcium bromide, calcium citrate, calcium chlorate, calcium gluconate, calcium hydroxide, calcium oxide, calcium hypochlorite, calcium iodate, calcium iodide, calcium lactate, calcium nitrite, calcium phosphate, calcium propionate, calcium sulfate, calcium sulfate hemihydrate, calcium sulfate dihydrate, calcium tartrate, calcium sulfamate, calcium maleinate, calcium fumarate, calcium aluminate, calcium methansulfonate and silicon dioxide in form of microsilica, silica fume or amorphous silica.

The particles with calcium and silicon in a molar ratio Ca/Si of 0.1 to 2.2 according to the invention can e.g. be characterized by electron microscopy (TEM/SEM) and the molar ratio can be determined using EDX elemental analysis in an electron microscope like TEM or SEM.

In one embodiment of the present invention, the hardening accelerator A further comprises a water-soluble polymer in an amount of from 0.1% to 50% by weight related to the dry weight of the hardening accelerator A.

The water-soluble polymer may be a comb polymer.

In one embodiment of the present invention, the comb polymer comprises, as units having acid functions, at least one structural unit of the general formulae (Ia), (Ib), (Ic) and/or (Id):

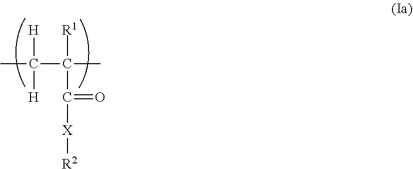

in which
R¹ is H or an unbranched or branched C₁-C₄ alkyl group, CH₂COOH or CH₂CO—X—R², preferably H or CH₃;
X is NH—(CₙH₂ₙ), O(CₙH₂ₙ) with n=1, 2, 3 or 4, where the nitrogen atom or the oxygen atom is bonded to the CO group, or is a chemical bond, preferably X is chemical bond or O(CₙH₂ₙ);
R² is OM, PO₃M₂, or O—PO₃M₂, with the proviso that X is a chemical bond if R² is OM;

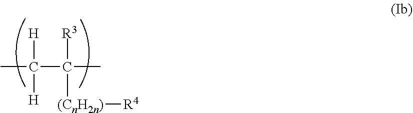

in which
R³ is H or an unbranched or branched C₁-C₄ alkyl group, preferably H or CH₃;
n is 0, 1, 2, 3 or 4, preferably 0 or 1;
R⁴ is PO₃M₂, or O—PO₃M₂;

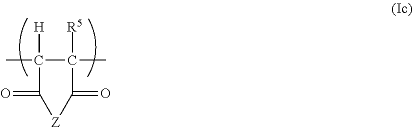

in which
R⁵ is H or an unbranched or branched C₁-C₄ alkyl group, preferably H;
Z is 0 or NR⁷, preferably O;
R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂, and
n is 1, 2, 3 or 4, preferably 1, 2 or 3;

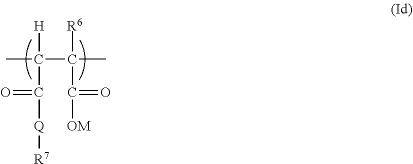

in which
R⁶ is H or an unbranched or branched C₁-C₄ alkyl group, preferably H;
Q is NR⁷ or O, preferably O;
R⁷ is H, (CₙH₂ₙ)—OH, (CₙH₂ₙ)—PO₃ M₂, (CₙH₂ₙ)—OPO₃M₂, (C₆H₄)—PO₃M₂, or (C₆H₄)—OPO₃M₂,
n is 1, 2, 3 or 4, preferably 1, 2 or 3; and
   each M independently of any other is H or a cation equivalent.

In one embodiment of the present invention, the comb polymer comprises as units having a polyether side chain at least one structural unit of the general formulae (IIa), (IIb), (IIc) and/or (IId):

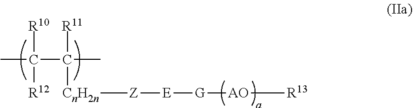

in which
R¹⁰, R¹¹ and R¹² independently of one another are H or an unbranched or branched C₁-C₄ alkyl group;
Z is O or S;
E is an unbranched or branched C₁-C₆ alkylene group, a cyclohexylene group, CH₂-C₆H₁₀, 1,2-phenylene, 1,3-phenylene or 1,4-phenylene;
G is O, NH or CO—NH; or
E and G together are a chemical bond;
A is CₓH₂ₓ with x=2, 3, 4 or 5, preferably 2 or 3, or is CH₂CH(C₆H₅);
n is 0, 1, 2, 3, 4 or 5, preferably 0, 1 or 2;
a is an integer from 2 to 350, preferably 5 to 150;
R¹³ is H, an unbranched or branched C₁-C₄ alkyl group, CO—NH₂ and/or COCH₃;

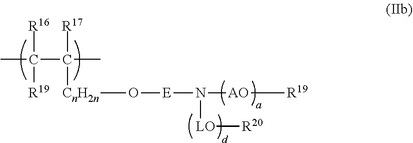

in which
R¹⁶, R¹⁷ and R¹⁸ independently of one another are H or an unbranched or branched C₁-C₄ alkyl group;
E is an unbranched or branched C₁-C₆ alkylene group, a cyclohexylene group, CH₂-C₆H₁₀, 1,2-phenylene, 1,3-phenylene, or 1,4-phenylene, or is a chemical bond;
A is CₓH₂ₓ with x=2, 3, 4 or 5, preferably 2 or 3, or is CH₂CH(C₆H₅);
n is 0, 1, 2, 3, 4 and/or 5, preferably 0, 1 or 2;
L is CₓH₂ₓ with x=2, 3, 4 or 5, preferably 2 or 3, or is CH₂—CH(C₆H₅);
a is an integer from 2 to 350, preferably 5 to 150;
d is an integer from 1 to 350, preferably 5 to 150;
R¹⁹ is H or an unbranched or branched C₁-C₄ alkyl group;
R²⁰ is H or an unbranched C₁-C₄ alkyl group;

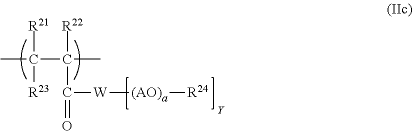

in which
R²¹, R²² and R²³ independently of one another are H or an unbranched or branched C₁-C₄ alkyl group;
W is O, NR²⁵, or is N;
Y is 1 if W=O or NR²⁵, and is 2 if W=N;
A is CₓH₂ₓ with x=2, 3, 4 or 5, preferably 2 or 3, or is CH₂CH(C₆H₅);
a is an integer from 2 to 350, preferably 5 to 150;
R24 is H or an unbranched or branched C₁-C₄ alkyl group; and
R²⁵ is H or an unbranched or branched C₁-C₄ alkyl group;

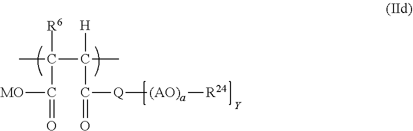

in which
R⁶ is H or an unbranched or branched C₁-C₄ alkyl group;
Q is NR¹⁰, N or O;
Y is 1 if W=O or NR¹⁰ and is 2 if W=N;
R¹⁰ is H or an unbranched or branched C₁-C₄ alkyl group; and
A is CₓH₂ₓ with x=2, 3, 4 or 5, preferably 2 or 3, or is CH₂C(C₆H₅)H;
R²⁴ is H or an unbranched or branched C₁-C₄ alkyl group;
M is H or a cation equivalent; and
a is an integer from 2 to 350, preferably 5 to 150.
   In one embodiment of the present invention, the comb polymer comprises a polyether side chain comprising:
   (a) at least one structural unit of the formula (IIa) in which R¹⁰ and R¹² are H, R¹¹ is H or CH₃, E and G together are a chemical bond, A is CₓH₂ₓ with x=2 and/or 3, a is 3 to 150, and R¹³ is H or an unbranched or branched C₁-C₄ alkyl group; and/or
   (b) at least one structural unit of the formula (IIb) in which R¹⁶ and R¹⁸ are H, R¹⁷ is H or CH₃, E is an unbranched or branched C₁-C₆ alkylene group, A is CₓH₂ₓ with x=2 and/or 3, L is CₓH₂ₓ, with x=2 and/or 3, a is an integer from 2 to 150, d is an integer from 1 to 150, R¹⁹ is H or an unbranched or branched C₁-C₄ alkyl group, and R²⁹ is H or an unbranched or branched C₁-C₄ alkyl group; and/or
   (c) at least one structural unit of the formula (IIc) in which R²¹ and R²³ are H, R²² is H or CH₃, A is CₓH₂ₓ with x=2 and/or 3, a is an integer from 2 to 150, and R²⁴ is H or an unbranched or branched C₁-C₄ alkyl group; and/or
   (d) at least one structural unit of the formula (IId) in which R⁶ is H, Q is O, R⁷ is (CₙH₂ₙ)—O—(AO)ₐ—R⁹, n is 2 and/or 3, A is CₓH₂ₓ with x=2 and/or 3, a is an integer from 1 to 150 and R⁹ is H or an unbranched or branched C₁-C₄ alkyl group.
   In one embodiment of the present invention, the comb polymer comprises at least one structural unit of the formula (IIa) and/or (IIc).
   In one embodiment of the present invention, the comb polymer comprises units of the formulae (I) and (II).
   In one embodiment of the present invention, the comb polymer comprises structural units of the formulae (Ia) and (IIa).
   In one embodiment of the present invention, the comb polymer comprises structural units of the formulae (Ia) and (IIc).
   In one embodiment of the present invention, the comb polymer comprises structural units of the formulae (Ic) and (IIa).
   In one embodiment of the present invention, the comb polymer comprises structural units of the formulae (Ia), (Ic) and (IIa).
   In one embodiment of the present invention, the comb polymer comprises (i) anionic or anionogenic structural units derived from acrylic acid, methacrylic acid, maleic acid, hydroxyethyl acrylate phosphoric acid ester, and/or hydroxyethyl methacrylate phosphoric acid ester, hydroxyethyl acrylate phosphoric acid diester, and/or hydroxyethyl methacrylate phosphoric acid diester, and (ii) polyether side chain structural units derived from C₁-C₄ alkyl-polyethylene glycol acrylic acid ester, polyethylene glycol acrylic acid ester, C₁-C₄ alkyl-polyethylene glycol methacrylic acid ester, polyethylene glycol methacrylic acid ester, C₁-C₄ alkyl-polyethylene glycol acrylic acid ester, polyethylene glycol acrylic acid ester, vinyloxy-C₂-C₄ alkylene-polyethylene glycol, vinyloxy-C₂-C₄ alkylene-polyethylene glycol C₁-C₄ alkyl ether, allyloxypolyethylene glycol, allyloxypolyethylene glycol C₁-C₄ alkyl ether, methallyloxy-polyethylene glycol, methallyloxy-polyethylene glycol C₁-C₄ alkyl ether, isoprenyloxy-polyethylene glycol and/or isoprenyloxy-polyethylene glycol C₁-C₄ alkyl ether.
   In one embodiment of the present invention, the comb polymer comprises structural units (i) and (ii) derived from
   (i) hydroxyethyl acrylate phosphoric acid ester and/or hydroxyethyl methacrylate phosphoric acid ester and (ii) C₁-C₄ alkyl-polyethylene glycol acrylic acid ester and/or C₁-C₄ alkyl-polyethylene glycol methacrylic acid ester; or
   (i) acrylic acid and/or methacrylic acid and (ii) C₁-C₄ alkyl-polyethylene glycol acrylic acid ester and/or C₁-C₄ alkyl-polyethylene glycol methacrylic acid ester; or
   (i) acrylic acid, methacrylic acid and/or maleic acid and (ii) vinyloxy-C₂-C₄ alkylene-polyethylene glycol, allyloxy-polyethylene glycol, methallyloxy-polyethylene glycol and/or isoprenyloxy-polyethylene glycol.
   In this connection, the comb polymer preferably comprises structural units (i) and (ii) derived from
   (i) hydroxyethyl methacrylate phosphoric acid ester and (ii) C₁-C₄ alkyl-polyethylene glycol methacrylic acid ester or polyethylene glycol methacrylic acid ester; or
   (i) methacrylic acid and (ii) C₁-C₄ alkyl-polyethylene glycol methacrylic acid ester or polyethylene glycol methacrylic acid ester; or
   (i) acrylic acid and maleic acid and (ii) vinyloxy-C₂-C₄ alkylene-polyethylene glycol or
   (i) acrylic acid and maleic acid and (ii) isoprenyloxy-polyethylene glycol or
   (i) acrylic acid and (ii) vinyloxy-C₂-C₄ alkylene-polyethylene glycol or
   (i) acrylic acid and (ii) isoprenyloxy-polyethylene glycol or
   (i) acrylic acid and (ii) methallyloxy-polyethylene glycol or
   (i) maleic acid and (ii) isoprenyloxy-polyethylene glycol or
   (i) maleic acid and (ii) allyloxy-polyethylene glycol or
   (i) maleic acid and (ii) methallyloxy-polyethylene glycol.
   In one embodiment of the present invention, the molar ratio of the structural units (I):(II) is 1:4 to 15:1, more particularly 1:1 to 10:1.

In one embodiment of the present invention, the comb polymer is a phosphorylated polycondensation product comprising structural units (III) and (IV):

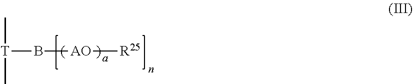

in which
is a substituted or unsubstituted phenyl or naphthyl radical or a substituted or unsubstituted heteroaromatic radical having 5 to 10 ring atoms, of which 1 or 2 atoms are heteroatoms selected from N, O and S;
n is 1 or 2;
B is N, NH or O, with the proviso that n is 2 if B is N and with the proviso that n is 1 if B is NH or O;
A is an unbranched or branched alkylene with 2 to 5 carbon atoms or CH₂CH(C₆H₅);
a is an integer from 1 to 300;
R²⁵ is H, a branched or unbranched C₁ to C₁₀ alkyl radical, C₅ to C₈ cycloalkyl radical, aryl radical, or heteroaryl radical having 5 to 10 ring atoms, of which 1 or 2 atoms are heteroatoms selected from N, O and S;
   where the structural unit (IV) is selected from the structural units (IVa) and (IVb):

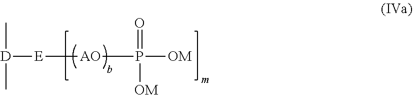

in which
D is a substituted or unsubstituted phenyl or naphthyl radical or a substituted or unsubstituted heteroaromatic radical having 5 to 10 ring atoms, of which 1 or 2 atoms are heteroatoms selected from N, O and S;
E is N, NH or O, with the proviso that m is 2 if E is N and with the proviso that m is 1 if E is NH or O;
A is an unbranched or branched alkylene with 2 to 5 carbon atoms or CH₂CH(C₆H₅);
b is an integer from 0 to 300;
M independently at each occurrence is H or a cation equivalent;

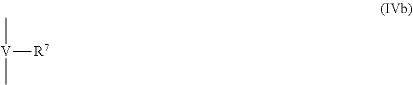

in which
V is a substituted or unsubstituted phenyl or naphthyl radical and is optionally substituted by 1 or two radicals selected from R⁸, OH, OR⁸, (CO)R⁸, COOM, COOR⁸, SO₃R⁸ and NO₂;
R⁷ is COOM, OCH₂COOM, SO₃M or OPO₃M₂;
M is H or a cation equivalent; and
R⁸ is C₁-C₄ alkyl, phenyl, naphthyl, phenyl-C₁-C₄ alkyl or C₁-C₄ alkylphenyl.
   In this connection, in formula III, T is preferably a substituted or unsubstituted phenyl radical or naphthyl radical, A is CₓH₂ₓ with x=2 and/or 3, a is an integer from 1 to 150, and R²⁵ is H, or a branched or unbranched C₁ to C₁₀ alkyl radical.
   In this connection, in formula IVa, D is preferably a substituted or unsubstituted phenyl radical or naphthyl radical, E is NH or O, A is CₓH₂ₓ with x=2 and/or 3, and b is an integer from 1 to 150.
   In this connection, T and/or D are preferably phenyl or naphthyl which is substituted by 1 or 2 C₁-C₄ alkyl, hydroxyl or 2 C₁-C₄ alkoxy groups.
   In this connection V is preferably phenyl or naphthyl which is substituted by 1 or 2 C₁-C₄ alkyl, OH, OCH₃ or COOM, and R⁷ is COOM or OCH₂COOM.
   In this connection, the polycondensation product comprises a further structural unit (V) of the formula

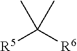

in which

R⁵ and R⁶ may be identical or different and are H, CH₃, COOH or a substituted or unsubstituted phenyl or naphthyl group or are a substituted or unsubstituted heteroaromatic group having 5 to 10 ring atoms, of which 1 or 2 atoms are heteroatoms selected from N, O and S.
In one embodiment of the present invention, R⁵ and R⁶ may be identical or different and are H, CH₃, or COOH, more particularly H, or one of the radicals R⁵ and R⁶ is H and the other is CH₃.

In one embodiment of the present invention, the molar weight of the polyether side chains is ≥200 g/mol, preferably ≥300 g/mol and ≤6000 g/mol, preferably ≤5000 g/mol.

In one embodiment of the present invention, the molecular weight of the polyether side chains is in the range from 200-6000 g/mol, more particularly 500-5000 g/mol and more preferably 1000-5000 g/mol.

In one embodiment of the present invention, where the charge density of the comb polymer is in the range from 0.5 meq/g-5 meq/g polymer, preferably 0.6 meq/g-3 meq/g polymer.

In a further embodiment, the water-soluble polymer is a copolymer comprising sulfo group containing units and/or sulfonate group-containing units and carboxylic acid and/or carboxylate group- containing units. In an embodiment, the sulfo or sulfonate group containing units are units derived from vinylsulfonic acid, methallylsulfonic acid, 4-vinylphenylsulfonic acid or are sulfonic acid-containing structural units of formula

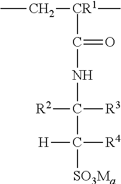

wherein
R² represents hydrogen or methyl
R², R³ and R⁴ independently of each other represent hydrogen, straight or branched C₁-C₆-alkyl or C₆-C₁₄-aryl,
M represents hydrogen, a metal cation, preferably a monovalent or divalent metal cation, or an ammonium cation
a represents 1 or 1/valency of the cation, preferably ½ or 1.

Preferred sulfo group containing units are derived from monomers selected from vinylsulfonic acid, methallylsulfonic acid, and 2-acrylamido-2-methylpropylsulfonic acid (AMPS) with AMPS being particularly preferred.

The carboxylic acid or carboxylate containing units are preferably derived from monomers selected from acrylic acid, methacrylic acid, 2-ethylacrylic acid, vinyl acetic acid, crotonic acid, maleic acid, fumaric acid, itaconic acid, citraconic acid, and in particular acrylic acid and methacrylic acid.

The sulfo group containing copolymer in general has a molecular weight M_{w} in the range from 1000 g/mol to 50,000 g/mol, preferably 1500 g/mol to 30,000 g/mol, as determined by aqueous gel permeation chromatography.

In an embodiment, the molar ratio between the sulfo group containing units and carboxylic acids containing units is, in general, in the range from 5:1 to 1:5, preferably 4:1 to 1:4.

Preferably the (co)polymer having carboxylic acid groups and/or carboxylate groups and sulfonic acid groups and/or sulfonate groups has a main polymer chain of carbon atoms and the ratio of the sum of the number of carboxylic acid groups and/or carboxylate groups and sulfonic acid groups and/or sulfonate groups to the number of carbon atoms in the main polymer chain is in the range from 0.1 to 0.6, preferably from 0.2 to 0.55. Preferably said (co)polymer can be obtained from a free-radical (co)polymerisation and the carboxylic acid groups and/or carboxylate groups are derived from monocarboxylic acid monomers. Preferred is a (co)polymer, which can be obtained from a free-radical (co)polymerisation and the carboxylic acid groups and/or carboxylate groups are derived from the monomers acrylic acid and/or methacrylic acid and the sulfonic acid groups and/or sulfonate groups are derived from 2-acrylamido-2-methylpropanesulfonic acid. Preferably the weight average molecular weight M_{w} of the (co)polymer(s) is from 8,000 g/mol to 200,000 g/mol, preferably from 10,000 to 50,000 g/mol. The weight ratio of the (co)polymer or (co)polymers to the calcium silicate hydrate is preferably from 1/100 to 4/1, more preferably from 1/10 to 2/1, most preferably from 1/5 to 1/1.

In one embodiment of the present invention, the water-soluble polymer is selected from

copolymers, comprising the structural units of formula (Ia) and (IIa), in particular copolymers, comprising structural units derived from acrylic and/or methacrylic acid and ethoxylated hydroxyalkylvinylether, such as ethoxylated hydroxybutyl-vinylether;

copolymers, comprising the structural units of formula (Ia), (Id) und (IIa), in particular copolymers, comprising structural units derived from acrylic acid and/or methacrylic acid, maleic acid, and ethoxylated hydroxyalkylvinylether, such as ethoxylated hydroxybutyl-vinylether;

copolymers, comprising the structural units of formula (Ia) und (IIc), in particular copolymers, comprising structural units derived from acrylic and/or methacrylic acid and esters of the acrylic and/or methacrylic acid with polyethylenglykol or polyethylenglykol, being endcapped with C₁-C₁₂-alkyl;

polycondensation products, comprising the structural units of formula (III), (IVa) and (V), in particular condensation products of ethoxylated phenol, phenoxy-C₂-C₆-alkanolphosphate and formaldehyde;

homopolymers, comprising sulfo- and/or sulfonate groups-containing units or carbon acid- and/or carboxylate groups-containing units;

copolymers, comprising sulfo- and/or sulfonate groups-containing units and carbon acid- and/or carboxylate groups-containing units; and/or

polyacrylic acid;

and salts thereof and combinations of two or more of these water-soluble polymers.

In one embodiment of the present invention, the hardening accelerator A comprises at least one further dispersant, preferably selected from the group consisting of lignosulfonates, melamine-formaldehydesulfonate-condensates, β-naphthalinsulfonic acid-condensate, phenolsulfonic acid-condensates and sulfonated keton-formaldehyde-condensates.

In one embodiment of the present invention, the hardening accelerator A comprises particles of calcium silicate, preferably calcium-silicate-hydrate (also referred to as C—S—H). The calcium-silicate-hydrate may contain foreign ions, such as magnesium and aluminum. The calcium-silicate-hydrate can be preferably described with regard to its composition by the following empirical formula:

a CaO, SiO₂, b Al₂O₃, c H₂O, d X, e W

X is an alkali metal
W is an alkaline earth metal

| | | |
|---|---|---|
| 0.5 ≤ a ≤ 2.5 | preferably | 0.66 ≤ a ≤ 2.0 |
| 0 ≤ b ≤ 1 | preferably | 0 ≤ b ≤ 0.1 |
| 1 ≤ c ≤ 6 | preferably | 1 ≤ c ≤ 6.0 |
| 0 ≤ d ≤ 1 | preferably | 0 ≤ d ≤ 0.4 or 0.2 |
| 0 ≤ e ≤ 2 | preferably | 0 ≤ e ≤ 0.1. |

Calcium-silicate-hydrate (also named as C—S—H) can be obtained preferably by reaction of a calcium compound with a silicate compound, preferably in the presence of a polycarboxylate ether (PCE). Such products containing calcium-silicate-hydrate are for example described in WO 2010/026155 A1, WO 2016097181, WO 2014/114784 or WO 2014/114782.

C—S—H may be provided, e.g., as low-density C—S—H, C—S—H gel, or C—S—H seeds. Preferably, the seed size of the C—S—H is small and can also be adjusted for example by milling of C—S—H. C—S—H seeds having an average diameter of less the 10 μm, preferably less than 2 μm, and in particular of less than 1 μm are preferred, determined by laser diffraction and data analysis according to Mie-theory according ISO13320:2009.

The water content of the C—S—H based hardening accelerator A in powder form is preferably from 0.1 weight % to 5.5 weight % with respect to the total weight of the powder sample. Said water content is measured by putting a sample into a drying chamber at 80° C. until the weight of the sample becomes constant. The difference in weight of the sample before and after the drying treatment is the weight of water contained in the sample. The water content (%) is calculated as the weight of water contained in the sample divided with the weight of the sample.

The calcium-silicate-hydrate may preferably be provided as an aqueous suspension. The water content of the aqueous suspension is preferably from 10 weight % to 95 weight %, preferably from 40 weight % to 90 weight %, more preferably from 50 weight % to 85 weight %, in each case the percentage is given with respect to the total weight of the aqueous suspension sample. The water content is determined in an analogous way as described in the before standing text by use of a drying chamber.

The hardening accelerator A may be provided in solid form or in liquid form. When provided as solid, the hardening accelerator A is preferably in powder from. A suitable liquid form of the hardening accelerator A may be an aqueous solution or aqueous suspension. The solid content of the liquid form is in the range of from 1 to 60 wt.-%, preferred from 5 wt.-% to 50 wt.-%, more preferred from 7 wt.-% to 40 wt.-%, based on the total weight of the liquid form. The solid content of the liquid form can be determined by drying to constant weight at 150° C. in a drying oven, with the weight difference found being regarded as the proportion of water (including bound water of solids in the suspension). When applied in liquid form, the hardening accelerator A is preferably an aqueous suspension.

Usually, a suspension containing the calcium-silicate-hydrate in finely dispersed form is obtained from the reaction of the calcium compound with the silicate compound. The suspension effectively accelerates the hardening process of hydraulic binders, in particular of ordinary Portland Cement. The suspension can be dried in a conventional manner, for example by spray drying or drum drying to give a powder.

Typically the calcium-silicate-hydrate in the composition is present in the form of foshagite, hillebrandite, xonotlite, nekoite, clinotobermorite , 9 Å-tobermorite (riversiderite), 11 Å-tobermorite, 14 Å-tobermorite (plombierite), jennite, metajennite, calcium chondrodite, afwillite, α-C2SH, dellaite, jaffeite, rosenhahnite, killalaite and/or suolunite. More preferably the calcium-silicate-hydrate in the composition, preferably aqueous hardening accelerator suspension, is xonotlite, 9 Å-tobermorite (riversiderite), 11 Å-tobermorite, 14 Å-tobermorite (plombierite), jennite, metajennite, afwillite and/or jaffeite.

In one embodiment of the present invention, the particle size d(50) of the hardening accelerator A in liquid form is smaller than 5 μm, preferably smaller than 2 μm, more preferably smaller than 1 μm, and in particular smaller than 500 nm, the particle size being measured by light scattering with a MasterSizer® 3000 from the company Malvern according to DIN ISO13320:2009.

In a preferred embodiment of the present invention, the particle size d(50) of the hardening accelerator A in liquid form is smaller than 2 μm, more preferably smaller than 1 μm, and in particular smaller than 500 nm, the particle size being measured by light scattering with a MasterSizer® 3000 from the company Malvern according to DIN ISO13320:2009.

In one embodiment of the present invention, the C—S—H is provided
in the form of powder particles having a diameter of less than 150 μm, wherein said powder particles comprise calcium-silicate-hydrate primary particles having a diameter of less than 200 nm, or
in the form of particles having a particle size distribution of d(50) <200 nm.

Without wishing to being bound by any theory, it is believed that small size particles of calcium-silicate-hydrate are especially effective as hardening accelerator.

In one embodiment of the present invention, the hardening accelerator A comprises a calcium-silicate-hydrate, which was obtained in the form of a suspension by a process α) by a reaction of a water-soluble calcium compound with a water-soluble silicate compound, the reaction of the water-soluble calcium compound with the water-soluble silicate compound being carried out in the presence of an aqueous solution which contains at least one polymeric dispersant, which contains anionic and/or anionogenic groups and polyether side chains, preferably poly alkylene glycol side chains, or was obtained in the form of a suspension by a process β) by reaction of a calcium compound, preferably a calcium salt, most preferably a water-soluble calcium salt, with a silicon dioxide containing component under alkaline conditions, wherein the reaction is carried out in the presence of an aqueous solution of at least one polymeric dispersant, which contains anionic and/or anionogenic groups and polyether side chains, preferably polyalkylene glycol side chains. To obtain the calcium-silicate-hydrate as a powder product, the suspension obtained from said processes α) or β) is dried in a further step in a conventional manner, for example by spray drying.

Examples for the processes αand β) are given in the international patent application published as WO 2010/026155 A1.

In one embodiment of the present invention, the hardening accelerator A comprises a calcium-silicate-hydrate, which was obtained in the form of a suspension by a process α−1) in which the water-soluble calcium compound is selected from calcium hydroxide and/or calcium oxide and the water-soluble silicate compound is selected from an alkali metal silicate with the formula m SiO₂.nM2O, wherein M is Li, Na, K or NH4 or mixtures thereof, m and n are molar numbers and the ratio of m:n is from about 2.0 to about 4 with the proviso that in the case of the calcium-silicate-hydrate based hydration accelerator in the hardening accelerator A being a powder product, the product in the form of a suspension obtained from said process α−1) was dried in a further step in order to obtain the powder product.

Generally, calcium hydroxide can also be produced from calcium hydroxide forming compounds, preferably calcium carbide can be contacted with water, which will release acetylene and calcium hydroxide.

Examples for the processes α), α−1), and β) are given in the international patent application published as WO 2010/026155 A1.

In one embodiment of the present invention, the hardening accelerator A comprises semi-ordered C—S—H with a crystallite size of less than 15 nm and at least one polymeric dispersant. The material was obtained for example by a process γ) by wet milling of C—S—H produced under hydrothermal conditions and where the milling was performed in presence of a water soluble dispersant.

Examples for the composition containing semi-ordered C—S—H and a polymeric dispersant are given in the international patent application published as WO 2018/154012 A1.

In one embodiment of the present invention, the hardening accelerator A comprises a calcium-silicate-hydrate, which is a suspension or which is a powder product and in which before the drying step to obtain the powder product in the case a) at least one polymeric dispersant, which has anionic and/or anionogenic groups and polyether side chains, preferably poly alkylene glycol side chains, was added to the product in the form of a suspension obtained from the process α), β), γ), or α−1) or in the case b) at least one sulfonic acid compound of the formula (I)

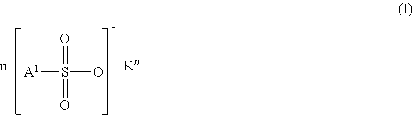

in which
A¹ is NH₂, NHMe, NMe₂, N(CH₂—CH₂—OH)₂, CH₃, C₂H₅, CH₂—CH₂—OH, phenyl, or p-CH₃-phenyl, and
Kⁿ⁺ is an alkali metal cation or a cation selected from the group of Ca²⁺, Mg²⁺, Sr²⁺, Ba²⁺, Zn²⁺, Fe²⁺, Fe³⁺, Al³⁺, Mn²⁺ and Cu²⁺ and
   n is the valency of the cation; was added to the product in the form of a suspension obtained from the process α), β), γ), or α−1). The valency of the cation means in particular its number of cationic charges, like for example if Kⁿ⁺ is Mg²⁺ then the valency of the magnesium ion is 2 (n=2).
   Preferably A¹ is NH₂, CH₃ and/or phenyl. Preferably Kⁿ⁺ is Ca²⁺.

In the case a) the at least one polymeric dispersant, which has anionic and/or anionogenic groups and polyether side chains, preferably poly alkylene glycol side chains, serves as a drying aid added to the suspensions obtained by the processes α), β) or α−1) before drying said suspensions. Examples of the case a) are given in the international patent application published as WO2012/143205.

In the case b) the sulfonic acid compound of the formula (I) serves as a drying aid added to the suspensions obtained by the processes α), β), γ), or α−1) before drying said suspensions.

In a preferred embodiment the polymeric dispersant used for the preparation of calcium-silicate-hydrate comprises at least one polymer (i.e. water-soluble polymer), which comprises structural units containing anionic and/or anionogenic groups and structural units containing polyether side chains. More particularly it is possible to use polymers containing relatively long side chains (with a molecular weight of in each case at least 200 g/mol, more preferably at least 400 g/mol) in varying distances on the main chain. Lengths of these side chains are often identical, but may also differ greatly from one another (for instance, in the case polyether macromonomers containing side chains of different lengths are copolymerized). Polymers of these kinds are obtainable, for example, by radical polymerization of acid monomers and polyether macromonomers. An alternative route to comb polymers of this kind is the esterification and/or amidation of poly(meth)acrylic acid and similar (co)polymers, such as acrylic acid/maleic acid copolymers, for example, with suitable monohydroxy-functional or monoamino-functional polyalkylene glycols, respectively, preferably alkyl polyethylene glycols. Comb polymers obtainable by esterification and/or amidation of poly(meth)acrylic acid are described for example in EP 1138697B1.

The average molecular weight Mw of said water-soluble polymers as determined by gel permeation chromatography (GPC) is 5,000 g/mol to 200,000 g/mol, preferably 10,000 g/mol to 80,000 g/mol, in particular 20,000 g/mol to 70,000 g/mol. The average molecular weight of the polymers was analyzed by means of GPC (column combinations: OH-Pak SB-G, OH-Pak SB 804 HQ and OH-Pak SB 802.5 HQ from Shodex, Japan; eluent: 80 vol % aqueous solution of HCO2NH4 (0.05 mol/I) and 20 vol % acetonitrile; injection volume 100 μl; flow rate 0.5 ml/min). Calibration for the purpose of determining the average molar mass was carried out with linear poly(ethylene oxide) standards and polyethylene glycol standards.

The polymeric dispersant preferably meets the requirements of industrial standard EN 934-2 (February 2002).

In one embodiment the construction material composition of the invention contains as the hardening accelerator A a combination of calcium-silicate-hydrate and at least one calcium salt having a solubility in water of at least 1 g in 1 liter of water at 23° C. Preference is given to calcium salts selected from the group comprising calcium chloride, calcium nitrate, calcium formate, calcium acetate, calcium bicarbonate, calcium bromide, calcium citrate, calcium chlorate, calcium gluconate, calcium hydroxide, calcium oxide, calcium hypochlorite, calcium iodate, calcium iodide, calcium lactate, calcium nitrite, calcium propionate, calcium sulfamate, calcium methansulfonate, calcium sulfate, calcium sulfate hemihydrate, calcium sulfate dihydrate, and mixtures of two or more of these components, in particular calcium nitrate, calcium acetate, calcium chloride, calcium hydroxide, calcium sulfamante or calcium formate, or a mixture thereof.

The amount of calcium-silicate-hydrate is preferably 0.1 to 4% by weight related to the dry weight of the hardening accelerator A based on the total dry weight of the construction material composition and the amount of calcium salt having a solubility in water of ≥1 g/I at 23° C. is preferably 0.1 to 4% by weight related to the dry weight of the hardening accelerator A, more preferably 0.5 to 2.5% by weight related to the dry weight of the hardening accelerator A based on the total dry weight of the construction material composition. The weight ratio of calcium-silicate-hydrate to calcium salt having a solubility in water of ≥1 g/I at 23° C. is in the range from 3:1 to 1:3.

Generally, the dosage of the hardening accelerator A further depends on the overall surface area for the construction material composition.

Preferred is a construction material composition, wherein the hardening accelerator A provides an acceleration factor of higher than 1.5, preferably higher than 2.0, in particular higher than 2.5. For the determination of the acceleration factor (AF) two norm mortar compositions according to DIN EN 196-1, one containing an amount of 2% by weight, based on the amount of ordinary Portland cement, of the hardening accelerator A and the other one without the accelerator, are prepared. The dry compositions are then mixed with water (water/cement ratio=0.4). The resulting cement pastes are then independently placed into an isothermal heat flow calorimeter (e.g. Tam Air by TA Instruments) at 20° C. The heat flows of both samples are recorded. The heat of hydration (HoH) is then calculated ac-cording to equation 1:

HoH=∫^{t}^{_{end}}ₜ_{_{begin}}Heat Flow dt , wherein t_{begin}=1800s and t_{end}=21600 s Equation 1

The acceleration factor (AF) is calculated according to equation 2:

AF=HoHacc/HoHref Equation 2

In one embodiment of the present invention, the construction material composition further comprises at least one additional hardening accelerator B. The at least one additional hardening accelerator B is a calcium-bearing compound different from anhydrous or hydrated calcium silicate, metal silicate hydrate, cement, or SCM's. In this connection, calcium aluminate, calcium hydroxide, calcium hydroxide nanoparticles, calcium oxide, calcium nitrate, calcium nitrite, calcium thiocyanate, calcium sulfate, calcium sulfate hemihydrate, calcium sulfate dihydrate, calcium acetate, calcium formate, calcium sulfamate, calcium methansulfonate, and calcium chloride should be named. In a particular embodiment of the preset invention the additional hardening accelerator B calcium sulfamate, calcium hydroxide, calcium hydroxide nanoparticles are further comprised in the construction material composition. The construction material composition may comprises the at least one additional hardening accelerator B in an amount of 0.1 to 5% by dry weight, preferably from 1 to 5% by dry weight, and in particular from 1.5 to 4% by dry weight, based on the total dry weight of the construction material composition.

In one embodiment, the hardening accelerator A, preferably a calcium-silicate-hydrate, and the at least one additional hardening accelerator B, preferably calcium hydroxide, calcium sulfamate or mixtures thereof, may be used in combination. In this connection, the weight ratio of C—S—H to Ca(OH)₂ may preferably be from 1:50 to 10:50, particularly preferably from 1:20 to 5:20.

In one embodiment of the present invention, the total SO₃ content and the total Al₂O₃ content determined by elemental analysis of the construction material composition are present in a weight ratio of from 1:10 to 5:1, preferably from 1:10 to 3:1, more preferably from 1:10 to 7:10, and in particular from 1:8 to 6:10.

In one embodiment of the present invention, the Portland cement clinker and the supplementary cementitious material are present in a weight ratio of from 2:1 to 1:5, preferably from 2:1 to 1:2, more preferably from 1.8:1 to 1:1.8 or from 1.8:1 to 1.5:1, or from 1.5:1 to 1:1, or from 1:1 to 1:2. In another preferred embodiment of the present invention, the Portland cement clinker and the supplementary cementitious material are present in a weight ratio of from 1.5:1 to 1:4.5, more preferably from 1:1 to 1:4, and in particular from 1:2 to 1:3.8.

In one embodiment of the present invention, the Portland cement clinker and the limestone are present in a weight ratio of from 4:1 to 1:2, preferably from 3.5:1 to 1:1.5, or from 3.5:1 to 3:1, or from 1.5:1 to 1:1, or from 1.3:1 to 1:1.5. In another preferred embodiment of the present invention, the Portland cement clinker and the limestone are present in a weight ratio of from 4:1 to 1:1, more preferably from 3.5:1 to 1.5:1, and in particular from 3:1 to 2:1.

In one embodiment of the present invention, the Portland cement clinker and the sulfate source selected from the group consisting of gypsum, bassanite, anhydrite, and mixtures thereof are present in a weight ratio of from 60:1 to 2:1, preferably from 55:1 to 5:1, more preferably from 55:1 to 20:1, or from 40:1 to 10:1, or from 20:1 to 5:1. In another preferred embodiment of the present invention, the Portland cement clinker and the sulfate source selected from the group consisting of gypsum, bassanite, anhydrite, and mixtures thereof are present in a weight ratio of from 40:1 to 2:1, more preferably from 20:1 to 1:2, and in particular from 10:1 to 3:1.

In one embodiment of the present invention, the Portland cement clinker and the hardening accelerator A are present in a weight ratio of from 40:1 to 5:1, preferably from 35:1 to 10:1, or from 25:1 to 5:1, or from 20:1 to 15:1.

In one embodiment of the present invention, the supplementary cementitious material and the limestone are present in a weight ration of from 10:1 to 1:2, preferably from 4:1 to 1:2, more preferably from 3:1 to 1:1.8. In another preferred embodiment of the present invention, the supplementary cementitious material and the limestone are present in a weight ration of from 10:1 to 2:1, more preferably from 10:1 to 3:1.

In one embodiment of the present invention, the supplementary cementitious material and the sulfate source are present in a weight ration of from 40:1 to 1:1, preferably from 30:1 to 4:1.

In one embodiment of the present invention, the construction material composition does not comprise alkanolamines. In another embodiment of the present invention, the construction material composition does not comprise carbohydrate. In yet another embodiment of the present invention, the construction material composition does not comprise alkanolamines and carbohydrate.

In a preferred embodiment of the present invention, the construction material composition comprises
a) Portland cement clinker in an amount of from 20 to 55% by dry weight based on the total dry weight of the construction material composition;
b) a supplementary cementitious material in an amount of from 20 to 50% by dry weight based on the total dry weight of the construction material composition;
c) a calcium carbonate phase in an amount of from 10 to 40% by dry weight based on the total dry weight of the construction material composition;
d) a sulfate source selected from the group consisting of gypsum, bassanite, anhydrite, and mixtures thereof in an amount of from more than 2.2 to 8 wt.-% of SO₃ based on the total dry weight of the construction material composition; and
e) a hardening accelerator A comprising particles with calcium and silicon in a molar ratio Ca/Si of 0.1 to 2.2 in an amount of from 0.1 to 5% by weight related to the weight of the sum of CaO and SiO₂ of the hardening accelerator A based on the total dry weight of the construction material composition.
   In a preferred embodiment of the present invention, the construction material composition comprises
a) the Portland cement clinker in an amount of from 40 to 55% by dry weight based on the total dry weight of the construction material composition;
b) the supplementary cementitious material in an amount of from 30 to 45% by dry weight based on the total dry weight of the construction material composition;
c) the calcium carbonate phase in an amount of from 15 to 30% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.1 to 5% by weight related to the weight of the sum of CaO and SiO₂ of the hardening accelerator A based on the total dry weight of the construction material composition

### Or

a) the Portland cement clinker in an amount of from 30 to 40% by dry weight based on the total dry weight of the construction material composition;
b) the supplementary cementitious material in an amount of from 30 to 45% by dry weight based on the total dry weight of the construction material composition;
c) the calcium carbonate phase in an amount of from 20 to 30% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.5 to 5% by weight related to the weight of the sum of CaO and SiO₂ of the hardening accelerator A based on the total dry weight of the construction material composition

### Or

a) Portland cement clinker in an amount of from 20 to 30% by dry weight based on the total dry weight of the construction material composition;
b) the supplementary cementitious material in an amount of from 30 to 50% by dry weight based on the total dry weight of the construction material composition;
c) the calcium carbonate phase in an amount of from 20 to 40% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 1.0 to 5% by weight related to the weight of the sum of CaO and SiO₂ of the hardening accelerator A based on the total dry weight of the construction material composition.

In a preferred embodiment of the present invention, the construction material composition comprises from more than 30 to 75% by dry weight, more preferably from 38 to 72% by dry weight, still more preferably from 45 to 71% by dry weight, an in particular from more than 50 to 70% by dry weight, of the supplementary cementitious material, based on the total dry weight of the construction material composition.

In a preferred embodiment of the present invention, the construction material composition comprises
a) the Portland cement clinker in an amount of from 15 to 47% by dry weight based on the total dry weight of the construction material composition;
b) the supplementary cementitious material in an amount of from more than 30 to 70% by dry weight based on the total dry weight of the construction material composition;
c) the calcium carbonate phase in an amount of from 5 to 20% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.1 to 5% by weight related to the weight of the sum of CaO and SiO₂ of the hardening accelerator A based on the total dry weight of the construction material composition,

preferably wherein the supplementary cementitious material comprises at least two different supplementary cementitious materials.

In a preferred embodiment of the present invention, the construction material composition comprises
a) the Portland cement clinker in an amount of from 15 to 30% by dry weight based on the total dry weight of the construction material composition;
b) the supplementary cementitious material in an amount of from more than 50 to 70% by dry weight based on the total dry weight of the construction material composition;
c) the calcium carbonate phase in an amount of from 5 to 20% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.1 to 5% by weight related to the weight of the sum of CaO and SiO₂ of the hardening accelerator A based on the total dry weight of the construction material composition,

preferably wherein the supplementary cementitious material comprises at least two different supplementary cementitious materials

In one embodiment of the present invention, the construction material composition additionally comprises at least one additive. The weight ratio of the construction material composition to additive is, in general, in the range from 10000:1 to 1:10000, preferably 5000:1 to 1:5000, in particular 1000:1 to 1:1000.

In one embodiment of the present invention, the construction material composition additionally comprises at least one additive, wherein preferably at least one additive is selected from the group consisting of inorganic carbonates, alkali metal sulfates, polymeric dispersants, hardening accelerators, hardening retarders, thickeners, and stabilizers or a mixture of two or more thereof.

Preferably, the additive is selected from at least one of the additives that are detailed in the following.

The construction material compositions may contain at least one alkali metal carbonate or alkaline earth metal carbonate, in particular sodium carbonate, potassium carbonate, magnesium carbonate, calcium carbonate and/or a mixed calcium-magnesium carbonate (CaMg(CO₃)₂. Especially the alkaline earth metal carbonates may be present in X-ray amorphous form. The carbonate is, in general, comprised in an amount in the range from about 1 to about 20 wt %, based on the weight of the inorganic binder.

Preferably, the compositions comprise at least one dispersant for the inorganic binder. In an embodiment, the dispersant is a polymeric dispersant, which has anionic and/or anionogenic groups and polyether side chains, which preferably comprise polyalkylene glycol side chains. The anionic and/or anionogenic groups and the polyether side chains are preferably attached to the backbone of the polymeric dispersant.

The dispersants are in this case more preferably selected from the group of polycarboxylate ethers (PCEs), the anionic group being in the case of PCEs carboxylic groups and/or carboxylate groups, and phosphorylated polycondensates. Most preferable are the polycarboxylate ethers (PCEs).

The PCE is preferably produced by the radical copolymerization of a polyether macromonomer and an acid monomer in a way that at least 45 mol-%, preferably at least 80 mol-% of all structural units of the copolymer were formed by copolymerization of the polyether macromonomer and the acid monomer. The term acid monomer means in particular a monomer comprising anionic and/or anionogenic groups. The term polyether macromonomer means in particular a monomer comprising at least two ether groups, preferably at least two alkylene glycol groups.

The polymeric dispersant preferably comprises as anionic and/or anionogenic group at least one structural unit of the general formulae (Ia), (Ib), (Ic) and/or (Id):

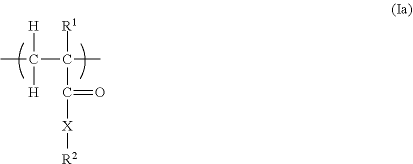

in which
R¹ is H or an unbranched or branched C₁-C₄ alkyl group, CH₂COOH or CH₂CO—X—R³;
X is NH—(CₙH₂ₙ) or O—(CₙH₂ₙ) with n=1, 2, 3 or 4, or is a chemical bond, where the nitrogen atom or the oxygen atom is bonded to the CO group;
R² is OM, PO₃M₂, or O—PO₃M₂; with the proviso that X is a chemical bond if R² is OM;
R³ is PO₃M₂, or O—PO₃M₂;

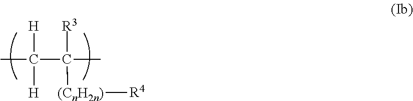

in which
R³ is H or an unbranched or branched C₁-C₄ alkyl group;
n is 0, 1, 2, 3 or 4;
R⁴ is PO₃M₂, or O—PO₃M₂;

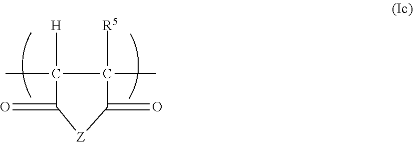

in which
R⁵ is H or an unbranched or branched C₁-C₄ alkyl group;
Z is O or NR⁷;
R⁷ is H, (CₙH₂ₙ)—OH, (CₙH₂)—PO₃ M₂, (CₙH₂ₙ)—OPO₃M₂, (C₆H₄)—PO₃M₂, or (C₆H₄)—OPO₃M₂, and
n is 1, 2, 3 or 4;

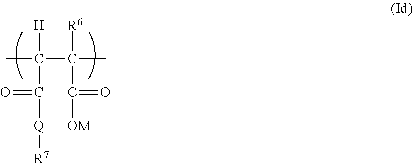

in which
R⁶ is H or an unbranched or branched C₁-C₄ alkyl group;
Q is NR⁷ or O;
R⁷ is H, (CₙH₂ₙ)—OH, (CₙH₂ₙ)—PO₃M₂, (CₙH₂ₙ)—OPO₃M₂, (C₆ H PO₃M₂, or (C₆H₄)—OPO₃M₂;
n is 1, 2, 3 or 4; and

where each M in the above formulae independently of any other is H or a cation equivalent.

Preferable is a composition where the polymeric dispersant comprises as polyether side chain at least one structural unit of the general formulae (IIa), (IIb), (IIc) and/or (IId):

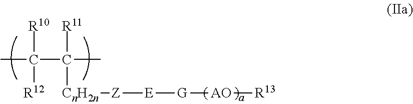

in which
R¹⁰, R¹¹ and R¹² independently of one another are H or an unbranched or branched C₁-C₄ alkyl group;
Z is O or S;
E is an unbranched or branched C₁-C₆ alkylene group, a cyclohexylene group, CH₂-C₆H₁₀, 1,2-phenylene, 1,3-phenylene or 1,4-phenylene;
G is O, NH or CO—NH; or
   E and G together are a chemical bond;
A is an unbranched or branched alkylene with 2, 3, 4 or 5 carbon atoms or CH₂CH(C₆H₅);
n is 0, 1, 2, 3, 4 or 5;
a is an integer from 2 to 350;
V is H, an unbranched or branched C₁-C₄ alkyl group, CO—N H₂ or COCH₃;

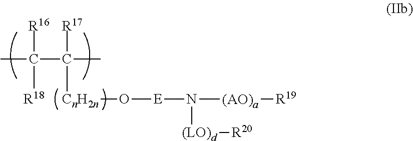

in which
R¹⁶, R¹⁷ and R¹⁸ independently of one another are H or an unbranched or branched C₁-C₄ alkyl group;
E is an unbranched or branched C₁-C₆ alkylene group, a cyclohexylene group, CH₂-C₆H₁₀, 1,2-phenylene, 1,3-phenylene, or 1,4-phenylene, or is a chemical bond;
A is an unbranched or branched alkylene with 2, 3, 4 or 5 carbon atoms or CH₂CH(C₆H₅);
n is 0, 1, 2, 3, 4 and/or 5;
L is CₓH₂ₓ with x=2, 3, 4 or 5, or is CH₂CH(C₆H₅);
a is an integer from 2 to 350;
d is an integer from 1 to 350;
R¹⁹ is H or an unbranched or branched C₁-C₄ alkyl group;
R20 is H or an unbranched C₁-C₄ alkyl group; and
n is 0, 1, 2, 3, 4 or 5;

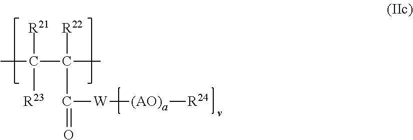

in which
R²¹, R²² and R²³ independently of one another are H or an unbranched or branched C₁-C₄ alkyl group;
W is O, NR²⁵, or is N;
V is 1 if W=0 or NR²⁵, and is 2 if W=N;
A is an unbranched or branched alkylene with 2 to 5 carbon atoms or CH₂CH(C₆H₅);
a is an integer from 2 to 350;
R²⁴ is H or an unbranched or branched C₁-C₄ alkyl group;
R²⁵ is H or an unbranched or branched C₁-C₄ alkyl group;

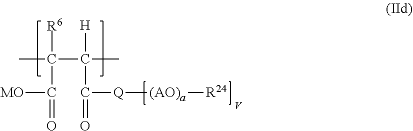

in which
R⁶ is H or an unbranched or branched C₁-C₄ alkyl group;
Q is NR¹⁰, N or O;
V is 1 if W=O or N¹⁰ and is 2 if W=N;
R¹⁰ is H or an unbranched or branched C₁-C₄ alkyl group;
A is an unbranched or branched alkylene with 2 to 5 carbon atoms or CH₂CH(C₆H₅); and
a is an integer from 2 to 350.
   In an embodiment, the polymeric dispersant is a phosphorylated polycondensation product comprising structural units (III) and (IV):

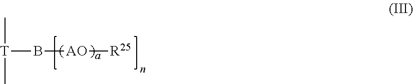

in which
T is a substituted or unsubstituted phenyl or naphthyl radical or a substituted or unsubstituted heteroaromatic radical having 5 to 10 ring atoms, of which 1 or 2 atoms are heteroatoms selected from N, O and S;
n is 1 or 2;
B is N, NH or O, with the proviso that n is 2 if B is N and with the proviso that n is 1 if B is NH or O;
A is an unbranched or branched alkylene with 2 to 5 carbon atoms or CH₂CH(C₆H₅);
a is an integer from 1 to 300;
R²⁵ is H, a branched or unbranched C₁ to C₁₀ alkyl radical, C₅ to C₈ cycloalkyl radical, aryl radical, or heteroaryl radical having 5 to 10 ring atoms, of which 1 or 2 atoms are heteroatoms selected from N, O and S;

where the structural unit (IV) is selected from the structural units (IVa) and (IVb):

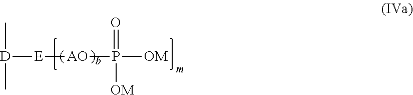

in which
D is a substituted or unsubstituted phenyl or naphthyl radical or a substituted or unsubstituted heteroaromatic radical having 5 to 10 ring atoms, of which 1 or 2 atoms are heteroatoms selected from N, O and S;
E is N, NH or O, with the proviso that m is 2 if E is N and with the proviso that m is 1 if E is NH or O;
A is an unbranched or branched alkylene with 2 to 5 carbon atoms or CH₂CH(C₆H₅);
b is an integer from 0 to 300;
M independently at each occurrence is H or a cation equivalent;

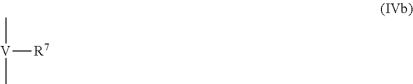

in which
V is a substituted or unsubstituted phenyl or naphthyl radical and is optionally substituted by 1 or two radicals selected from R⁸, OH, OR⁸, (CO)R⁸, COOM, COOR⁸, SO₃R⁸ and NO₂;
R⁷ is COOM, OCH₂COOM, SO₃M or OPO₃M₂;
M is H or a cation equivalent; and
R⁸ is C₁-C₄ alkyl, phenyl, naphthyl, phenyl-C₁-C₄ alkyl or C₁-C₄ alkylphenyl.

The polymeric dispersants comprising structural units (I) and (II) can be prepared by conventional methods, for example by free radical polymerization. The preparation of the dispersants is, for example, described in EP0894811, EP1851256, EP2463314, and EP0753488.

In a preferred embodiment, the dispersant is a polymer comprising a sulfonic acid and/or sulfonate group. In an embodiment, the polymeric dispersant comprising sulfonic acids and/or sulfonates and is selected from the group consisting of lignosulfonates (LGS), melamine formaldehyde sulfonate condensates (MES), β-naphthalene sulfonic acid condensates (BNS), sulfonated ketone-formaldehyde-condensates, and copolymers comprising sulfo group containing units and/or sulfonate group-containing units and carboxylic acid and/or carboxylate group-containing units.

The lignosulfonates used as polymeric sulfonated dispersants are products, which are obtained as by-products of the paper industry. Such products are described in Ullmann's Encyclopedia of Industrial Chemistry, 5th Ed., Vol. A8, pages 586, 587. They comprise units of the strongly simplified and idealized formula

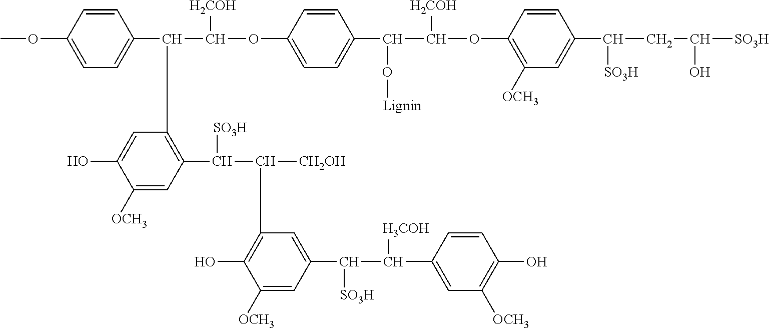

wherein n is usually 5 to 500. Lignosulfonates have usually molecular weights between 2.000 and 100.000 g/mol. Generally, they are present in the form of their sodium-, calcium-, and/or magnesium salts. Examples for suitable lignosulfonates are the products marketed under the trade name Borresperse of the Norwegian company Borregaard LignoTech.

The melamine-formaldehyde-sulfonate condensates (also called MFS-resins) and their preparation are for example described in CA 2 172 004 A1, DE 44 11 797 A1, U.S. Pat. Nos. 4,430,469, 6,555,683 and CH 686 186, as well as in “Ullmann's Encyclopedia of Industrial Chemistry, 5th Ed., Vol. A2, page 131” and “Concrete Admixtures Handbook—Properties, Science and Technology, 2nd Ed., pages 411, 412”. Preferred melamine-formaldehyde-sulfonate condensates comprise (strongly simplified and idealized) units of the formula

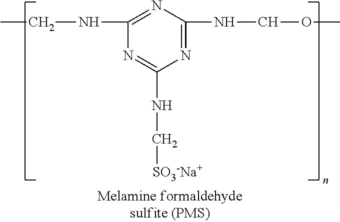

wherein n is typically a number from 10 to 300. The molecular weight is preferably in the region from 2.500 to 80.000 g/mol. An example for melamine-formaldehyde-sulfonate condensates are products marketed by the company BASF Construction Additives GmbH under the trade name Melmenr.

In addition to the sulfonated melamine units additional monomers can be co-condensated. In particular urea is suitable. Furthermore aromatic building units like gallic acid, aminobenzene sulfonic acid, sulfanilic acid, phenol sulfonic acid, aniline, ammonium benzoic acid, dialkoxybenzene sulfonic acid, dialkoxybenzoic acid, pyridine, pyridine monosulfonic acid, pyridine disulfonic acid, pyridine carboxylic acid and pyridine dicarboxylic acid can be co-condensated into the melamine-formaldehyde-sulfonate condensates.

The sulfonated ketone-formaldehyde are products in which as ketone component a mono- or diketone is used. Preferably acetone, butanone, pentanone, hexanone or cyclohexanone are built into the polymer. Such condensates are known and for example described in WO 2009/103579. Preferable are sulfonated acetone-formaldehyde-condensates. They comprise typically units of the formula (according to J. Plank et al., J. Appl. Poly. Sci. 2009, 2018-2024):

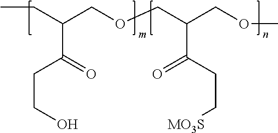

wherein m and n are typically an integer from 10 to 250, M is an alkali metall ion, for example Na³⁰, and the ratio of m:n is generally in the region from about 3:1 to about 1:3, in particular from about 1,2:1 to about 1:1,2. Examples for suitable acetone-formaldehyde-condensates are products, which are marketed by the company BASF Construction Solutions GmbH under the trade name Melcret® K1L.

Furthermore aromatic building units like gallic acid, aminobenzene sulfonic acid, sulfanilic acid, phenol sulfonic acid, aniline, ammonium benzoic acid, dialkoxybenzene sulfonic acid, dialkoxybenzoic acid, pyridine, pyridine monosulfonic acid, pyridine disulfonic acid, pyridine carboxylic acid and pyridine dicarboxylic acid can be co-condensated.

The β-naphthaline-formaldehyde-condensates (BNS) are products, which are obtained by a sulfonation of naphthaline followed by a polycondensation with formaldehyde. Such products are described amongst others in “Concrete Admixtures Handbook—Properties, Science and Technology, 2nd Ed., pages 411-413” and “Ullmann's Encyclopedia of Industrial Chemistry, 5th Ed., Vol. A8, pages 587, 588”. They comprise units of the formula

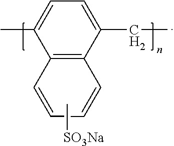

Typically the molecular weight (M_{w}) is from 1.000 to 50.000 g/mol.

Examples for suitable β-naphthaline-formaldehyde-condensates are the products marketed by the company BASF Construction Additives GmbH under the trade name Melcret® 500 L.

Furthermore aromatic building units like gallic acid, aminobenzene sulfonic acid, sulfanilic acid, phenol sulfonic acid, aniline, ammonium benzoic acid, dialkoxybenzene sulfonic acid, dialkoxybenzoic acid, pyridine, pyridine monosulfonic acid, pyridine disulfonic acid, pyridine carboxylic acid and pyridine dicarboxylic acid can be co-condensated.

In a further embodiment, the dispersant is a copolymer comprising sulfo group containing units and/or sulfonate group-containing units and carboxylic acid and/or carboxylate group-containing units. In an embodiment, the sulfo or sulfonate group containing units are units derived from vinylsulfonic acid, methallylsulfonic acid, 4-vinylphenylsulfonic acid or are sulfonic acid-containing structural units of formula

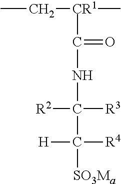

wherein
R² represents hydrogen or methyl
   R², R³ and R⁴ independently of each other represent hydrogen, straight or branched C₁-C₆-alkyl or C₆-C₁₄-aryl,
   M represents hydrogen, a metal cation, preferably a monovalent or divalent metal cation, or an ammonium cation
a represents 1 or 1/valency of the cation, preferably ½ or 1.

Preferred sulfo group containing units are derived from monomers selected from vinylsulfonic acid, methallylsulfonic acid, and 2-acrylamido-2-methylpropylsulfonic acid (AMPS) with AMPS being particularly preferred.

The carboxylic acid or carboxylate containing units are preferably derived from monomers selected from acrylic acid, methacrylic acid, 2-ethylacrylic acid, vinyl acetic acid, crotonic acid, maleic acid, fumaric acid, itaconic acid, citraconic acid, and in particular acrylic acid and methacrylic acid.

The sulfo group containing copolymer in general has a molecular weight M_{w} in the range from 1000 g/mol to 50,000 g/mol, preferably 1500 g/mol to 30,000 g/mol, as determined by aqueous gel permeation chromatography.

In an embodiment, the molar ratio between the sulfo group containing units and carboxylic acids containing units is, in general, in the range from 5:1 to 1:5, preferably 4:1 to 1:4.

Preferably the (co)polymer having carboxylic acid groups and/or carboxylate groups and sulfonic acid groups and/or sulfonate groups has a main polymer chain of carbon atoms and the ratio of the sum of the number of carboxylic acid groups and/or carboxylate groups and sulfonic acid groups and/or sulfonate groups to the number of carbon atoms in the main polymer chain is in the range from 0.1 to 0.6, preferably from 0.2 to 0.55. Preferably said (co)polymer can be obtained from a free-radical (co)polymerisation and the carboxylic acid groups and/or carboxylate groups are derived from monocarboxylic acid monomers. Preferred is a (co)polymer, which can be obtained from a free-radical (co)polymerisation and the carboxylic acid groups and/or carboxylate groups are derived from the monomers acrylic acid and/or methacrylic acid and the sulfonic acid groups and/or sulfonate groups are derived from 2-acrylamido-2-methylpropanesulfonic acid. Preferably the weight average molecular weight M_{w} of the (co)polymer(s) is from 8,000 g/mol to 200,000 g/mol, preferably from 10,000 to 50,000 g/mol. The weight ratio of the (co)polymer or (co)polymers to the calcium silicate hydrate is preferably from 1/100 to 4/1, more preferably from 1/10 to 2/1, most preferably from 1/5 to 1/1.

It is also possible to use mixtures of the before mentioned dispersants, for example mixtures of lignosulfonates (LGS), melamine formaldehyde sulfonate condensates (MES), β-naphthalene sulfonic acid condensates (BNS), copolymers comprising sulfo group containing units and/or sulfonate group-containing units and carboxylic acid and/or carboxylate group-containing units, sulfonated keton-formaldehyde-condensates, polycarboxylate ethers (PCE) and/or phosphorylated polycondensates. A preferred mixture comprises copolymers comprising sulfo group containing units and/or sulfonate group-containing units and carboxylic acid and/or carboxylate group-containing units and/or phosphorylated polycondensates.

In an embodiment, the dispersant is a) a non-ionic copolymer for extending workability to the construction material compositions in the form of a paste (cementitious mixture), wherein the copolymer comprises residues of at least the following monomers: Component A comprising an ethylenically unsaturated carboxylic acid ester monomer comprising a moiety hydrolysable in the cementitious mixture, wherein the hydrolysed monomer residue comprises an active binding site for a component of the cementitious mixture; and

Component B comprising an ethylenically unsaturated carboxylic acid ester or alkenyl ether monomer comprising at least one C₂₋₄ oxyalkylene side group of 1 to 350 units or b) a phosphonate-containing polymer of the formula

R—(OA)ₙ—N—[CH₂—PO(OM₂)₂]₂

wherein

R is H or a saturated or unsaturated hydrocarbon group, preferably a C₁ to C₁₅ radical,

A is the same or different and independently from each other an alkylene with 2 to 18 carbon atoms, preferably ethylene and/ or propylene, most preferably ethylene,

N is an integer from 5 to 500, preferably 10 to 200, most preferably 10 to 100, and

M is H, an alkali metal, ½ alkaline earth metal and/or amine.

In one embodiment of the present invention, the construction material composition additionally comprised at least one polymeric dispersant, in particular a polycarboxylate ether, phosphorylated polycondensation product or a sulfonic acid and/or sulfonate group containing dispersant.

In one embodiment of the present invention, the construction material composition additionally comprises at least one polymeric dispersant, which is a sulfonic acid and/or sulfonate group containing dispersant selected from the group consisting of lignosulfonates, melamine formaldehyde sulfonate condensates, beta-naphthalene sulfonic acid condensates, sulfonated ketone-formaldehyde-condensates, and copolymers comprising sulfo group containing units and/or sulfonate group-containing units and carboxylic acid and/or carboxylate group-containing units.

As indicated above, the present invention further relates in one embodiment to the use of a hardening accelerator A comprising particles with calcium and silicon in a molar ratio Ca/Si of 0.1 to 2.2 in a construction material composition comprising at most 55% by dry weight of Portland cement clinker based on the total dry weight of the construction material composition, wherein the hardening accelerator A is present in the construction material composition in an amount of from 0.1 to 5% by weight related to the weight of the sum of CaO and SiO₂ of the hardening accelerator A based on the total dry weight of the construction material composition.

The invention also concerns the use of the construction material composition of the invention as an inorganic binder for inorganic binder containing building material formulations and/or for producing building products, in particular for concretes such as on-site concrete, finished concrete parts, pre-cast concrete parts, concrete goods, cast concrete stones, concrete bricks, in-situ concrete, sprayed concrete (shotcrete), ready-mix concrete, air-placed concrete

The invention also concerns the use of the construction material composition of the invention as an inorganic binder for inorganic binder containing building material formulations and/or for producing building products, in particular for dry mortars such as concrete repair systems, repair mortar, industrial cement flooring, one-component and two-component sealing slurries, screeds, filling and self-levelling compositions, such as joint fillers or self-levelling underlayments, adhesives, such as building or construction adhesives, external or internal thermal insulation composite system (ETICS) adhesives, tile adhesives, grouts, such as joint grouts, non-shrink grouts, tile grouts, wind-mill grouts, anchor grouts, flowable or self-levelling grouts, EIFS grouts (Exterior Insulation Finishing Systems), screeds, or waterproofing membranes.

The invention also concerns the use of the construction material composition of the invention as an inorganic binder for inorganic binder containing building material formulations and/or for producing building products, in particular for fabricated products such as cementitious foams, cementitious boards, autoclaved aerated concrete, cementitious fiber boards, or cementitious roof tiles.

According to a preferred embodiment of the present invention, the construction material composition comprises less than 40% by dry weight, preferably less than 35% by dry weight, more preferably less than 30% by dry weight, and in particular less than 25% by dry weight, of components, which are declared hazardous according to GHS08, based on the total % by dry weight of the construction material composition. It is further preferred that the construction material composition comprises from 0 to less than 40% by dry weight, preferably from 0 to less than 35% by dry weight, more preferably from 0 to less than 30% by dry weight, and in particular from 0 to less than 25% by dry weight, of components, which are declared hazardous according to GHS08, based on the total % by dry weight of the construction material composition.

In this connection it is particularly preferred that the construction material composition comprises less than 40% by dry weight, preferably less than 35% by dry weight, more preferably less than 30% by dry weight, and in particular less than 25% by dry weight, of fine quartz (also known as quartz powder), based on the total % by dry weight of the construction material composition. It is further preferred that the construction material composition comprises from 0 to less than 40% by dry weight, preferably from 0 to less than 35% by dry weight, more preferably from 0 to less than 30% by dry weight, and in particular 0 to less than 25% by dry weight, of fine quartz, based on the total % by dry weight of the construction material composition. The term “fine quartz” according to the present invention refers to fine quartz with a maximum grain size of at most 63 μm.

In one embodiment of the present invention, the construction material composition is as above-described in more detail.

In one embodiment of the present invention, the construction material composition is as claimed.

As indicated above, the present invention further relates in one embodiment to a mortar or concrete comprising a construction material composition as claimed. Further details on the construction material composition may be found in the above description. In this connection, mortars, such as dry mortars, sag resistant, flowable or self-levelling mortars, drainage mortars, or repair mortars and concretes such as on-site concrete, finished concrete parts, pre-cast concrete parts, concrete goods, cast concrete stones, concrete bricks, in-situ concrete, sprayed concrete (shotcrete), ready-mix concrete, air-placed concrete, concrete repair systems should be named.

In a particular embodiment of the present invention, the mortar comprises a dispersant. Suitable dispersants are above-described in more detail.

In one embodiment of the present invention, the mortar comprises at least one polymeric dispersant, in particular a polycarboxylate ether, phosphorylated polycondensation product or a sulfonic acid and/or sulfonate group containing dispersant.

In one embodiment of the present invention, the mortar comprises at least one polymeric dispersant, which is a sulfonic acid and/or sulfonate group containing dispersant selected from the group consisting of lignosulfonates, melamine formaldehyde sulfonate condensates, beta-naphthalene sulfonic acid condensates, sulfonated ketone-formaldehyde-condensates, and copolymers comprising sulfo group containing units and/or sulfonate group-containing units and carboxylic acid and/or carboxylate group-containing units.

As indicated above, the present invention further relates in one embodiment to a process for producing a construction material composition as claimed. Further details on the construction material composition may be found in the above description.

In one embodiment of the present invention, the calcium carbonate phase is provided as a powder. In one embodiment of the present invention, the hardening accelerator A is provided as a suspension. Preferably, the calcium carbonate phase is provided as a powder and the hardening accelerator A is provided as a suspension.

In a preferred embodiment, the process comprises the step of mixing the calcium carbonate with the hardening accelerator A.

In one embodiment, the present invention relates to a process for producing a construction material composition as claimed, wherein the addition of hardening accelerator A is done during or after blending components a) to d). Blending can be done by co-grinding of all components a) to e). Blending can further be done in several steps where for example in step 1 component a) is co-grinded with component d), in step 2 mixture of a) and d) is blended with component b) and c) and component e) is added during or after step 1 or step 2.

Preferably component e) is added after blending of components a) to d).

Especially preferred is the addition of component e) at temperatures below 150° C. when the component e) is in the form of a suspension or at temperatures below 120° C., more preferred below 100° C. when the component e) is in form of a powder.

The present invention is further directed to the following embodiments. It is to be understood that each preferred embodiment is relevant on its own as well as in combination with other preferred embodiments.

In a preferred embodiment, the present invention relates to a construction material composition comprising
a) Portland cement clinker in an amount of from 20 to 55% by dry weight based on the total dry weight of the construction material composition;
b) a supplementary cementitious material in an amount of from 20 to 50% by dry weight based on the total dry weight of the construction material composition;
c) a calcium carbonate phase in an amount of from 10 to 40% by dry weight based on the total dry weight of the construction material composition;
d) a sulfate source selected from the group consisting of gypsum, bassanite, anhydrite, and mixtures thereof in an amount of from more than 2.2 to 8 wt.-% of SO₃ based on the total dry weight of the construction material composition; and
e) a hardening accelerator A comprising particles with calcium and silicon in a molar ratio Ca/Si of 0.1 to 2.2 in an amount of from 0.1 to 5% by weight related to the weight of the sum of CaO and SiO₂ of the hardening accelerator A based on the total dry weight of the construction material composition.

In a preferred embodiment, the present invention relates to the construction material composition according to the previous embodiment, wherein the supplementary cementitious material is selected from the group consisting of slag, fly ash, natural pozzolans, calcinated clay, silica fume, and mixtures thereof.

In a preferred embodiment, the present invention relates to the construction material composition according to any one of the previous embodiments, wherein the calcium carbonate phase is selected from limestone, dolomite, calcite, aragonite, vaterite, and mixtures thereof.

In a preferred embodiment, the present invention relates to the construction material composition according to any one of the previous embodiments, wherein the total SO₃ content and the total Al₂O₃ content determined by elemental analysis are present in a weight ratio of from 1:10 to 5:1.

In a preferred embodiment, the present invention relates to the construction material composition according to any one of the previous embodiments, wherein the Portland cement clinker and the supplementary cementitious material are present in a weight ratio of from 2:1 to 1:2.

In a preferred embodiment, the present invention relates to the construction material composition according to any one of the previous embodiments, wherein the Portland cement clinker and the limestone are present in a weight ratio of from 4:1 to 1:2.

In a preferred embodiment, the present invention relates to the construction material composition according to any one of the previous embodiments, wherein the hardening accelerator A further comprises a water soluble polymer in an amount of from 0.1% to 50% by weight related to the dry weight of the hardening accelerator A.

In a preferred embodiment, the present invention relates to the construction material composition according to any one of the previous embodiments, wherein the hardening accelerator A comprises particles which are calcium-silicate-hydrate of the following empirical formula

a CaO, SiO₂, b Al₂O₃, c H₂O, d X, e W

X is an alkali metal
W is an alkaline earth metal

| | | |
|---|---|---|
| 0.5 ≤ a ≤ 2.5 | preferably | 0.66 ≤ a ≤ 2.0 |
| 0 ≤ b ≤ 1 | preferably | 0 ≤ b ≤ 0.1 |
| 1 ≤ c ≤ 6 | preferably | 1 ≤ c ≤ 6.0 |
| 0 ≤ d ≤ 1 | preferably | 0 ≤ d ≤ 0.4 or 0.2 |
| 0 ≤ e ≤ 2 | preferably | 0 ≤ e ≤ 0.1. |

In a preferred embodiment, the present invention relates to the construction material composition according to any one of the previous embodiments, wherein the composition comprises
a) the Portland cement clinker in an amount of from 40 to 55% by dry weight based on the total dry weight of the construction material composition;
b) the supplementary cementitious material in an amount of from 30 to 45% by dry weight based on the total dry weight of the construction material composition;
c) the calcium carbonate phase in an amount of from 15 to 30% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.1 to 5% by weight related to the weight of the sum of CaO and SiO₂ of the hardening accelerator A based on the total dry weight of the construction material composition.

In a preferred embodiment, the present invention relates to the construction material composition according to any one of the previous embodiments, wherein the composition comprises
a) the Portland cement clinker in an amount of from 30 to 40% by dry weight based on the total dry weight of the construction material composition;
b) the supplementary cementitious material in an amount of from 30 to 45% by dry weight based on the total dry weight of the construction material composition;
c) the calcium carbonate phase in an amount of from 20 to 30% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.5 to 5% by weight related to the weight of the sum of CaO and SiO₂ of the hardening accelerator A based on the total dry weight of the construction material composition.

In a preferred embodiment, the present invention relates to the construction material composition according to any one of the previous embodiments, wherein the composition comprises
a) Portland cement clinker in an amount of from 20 to 30% by dry weight based on the total dry weight of the construction material composition;
b) the supplementary cementitious material in an amount of from 30 to 50% by dry weight based on the total dry weight of the construction material composition;
c) the calcium carbonate phase in an amount of from 20 to 40% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 1.0 to 5% by weight related to the weight of the sum of CaO and SiO₂ of the hardening accelerator A based on the total dry weight of the construction material composition.

In a preferred embodiment, the present invention relates to the construction material composition according to any one of the previous embodiments, additionally comprising at least one additive, wherein preferably the at least one additive is selected from the group consisting of inorganic carbonates, alkali metal sulfates, polymeric dispersants, hardening accelerators, hardening retarders, thickeners, and stabilizers or a mixture of two or more thereof.

In a preferred embodiment, the present invention relates to the construction material composition according to any one of the previous embodiments, additionally comprising at least one polymeric dispersant, in particular a polycarboxylate ether, phosphorylated polycondensation product or a sulfonic acid and/or sulfonate group containing dispersant.

In a preferred embodiment, the present invention relates to the construction material composition according to any one of the previous embodiments, additionally comprising at least one polymeric dispersant, which is a sulfonic acid and/or sulfonate group containing dispersant selected from the group consisting of lignosulfonates, melamine formaldehyde sulfonate condensates, beta-naphthalene sulfonic acid condensates, sulfonated ketone-formaldehyde-condensates, and copolymers comprising sulfo group containing units and/or sulfonate group-containing units and carboxylic acid and/or carboxylate group-containing units.

In a preferred embodiment, the present invention relates to the construction material composition according to any one of the previous embodiments, additionally comprising at least one hardening accelerator B.

In a preferred embodiment, the present invention relates to the use of a hardening accelerator A comprising particles with calcium and silicon in a molar ratio Ca/Si of 0.1 to 2.2 in a construction material composition comprising at most 55% by dry weight of Portland cement clinker based on the total dry weight of the construction material composition, wherein the hardening accelerator A is present in the construction material composition in an amount of from 0.1 to 5% by weight related to the weight of the sum of CaO and SiO₂ of the hardening accelerator A based on the total dry weight of the construction material composition.

In a preferred embodiment, the present invention relates to the use according to the previous embodiment, wherein the construction material composition is as defined in any one of the previous embodiments.

In a preferred embodiment, the present invention relates to a mortar or concrete comprising a construction material composition according to any one of the previous embodiments.

In a preferred embodiment, the present invention relates to a process for producing a construction material composition according to any one of the previous embodiments, wherein the calcium carbonate phase is provided as a powder and the hardening accelerator A is provided as a suspension.

The present invention is further illustrated by the following examples.

### EXAMPLES

The OPC used was Milke CEM I 52.5 R (d₅₃=5.1 μm) having a Portland cement clinker content of 95 wt.-% based on the total amount of OPC and Mergelstetten CEM I 42.5 N having a Portland cement clinker content of 90 wt.-% based on the total amount of OPC (d₅₀=19.44 μm).
The limestone used was purchased from Omya and is available under the tradename Omyacarb 15 AL (d₅₀=15).
The Anhydrite (CAB 30) used was calcium sulfate purchased from LANXESS Deutschland GmbH.
The hardening accelerator A (named CSH) was produced in two steps: Step 1—obtaining a suspension of CSH according to WO2018/154012A1 example suspension S11 in table 4. The resulting suspension was additionally dried in a Step 2 according to WO2014/114784A1, example TH1-q in table 4, where instead of suspension H1 the suspension of Step 1 was used. The final molar Ca/Si ratio of the particles with calcium and silicon in a molar ratio Ca/Si of 0.1 to 2.2 in hardening accelerator A is 1.85.
Calcinated Clay used was purchased from Tara Society, India, d₅₃=12.0 μm).
Slag (Moerdijk 4500) was purchased from Ecocem, d₅₃=10.0 μm.
Fly ash class F was purchased from Powerment HKV, d₅₃=14.5 μm.
Microsilica RW Q1-Filler was purchased from RW Silicium GmbH, d₅₃=0.1-0.3 μm.
Quarz powder M8 was purchased from Sibelco, d50 =27 μm, Blaine =3200 cm²/g.

### Additives:

Plasticizer Glenium ACE 30 by BASF Schweiz AG, which is a superplasticizer based on polycarboxylate ethers and has a solid content of 30.0 wt.-%.

### Defoamer Vinapor DF 9010 F by BASF Construction Additives GmbH

### Stabilizer Starvis 3040 F by BASF Construction Additives GmbH

The strength was measured with standard mortar test according to according to DIN EN 196-1:2005 with an amount of 225 g total water per mixture. The water amount refers to a water/cement ratio of 0.5 in case of pure cement used (comparative example 0 in table 1). To compare the different mortars at same slump flow a plasticizer was used to set the slump flow to 17 cm±1 cm. In comparative mortars an amount of 1.5 g per 1800 g mortar was used. In inventive samples with addition of CSH no further plasticizer was needed to achieve the target slump flow.
To adapt the air content each mortar mix contains 0.5 g defoamer and to prevent segregation of the mortar 0.5 g of a stabilizer were added.
Standard mortar test was carried out for limestone calcined clay cement (LC³) system. The hardening accelerator A (named as CSH) was tested at the dosage of 1.5 and 3 wt.-% (see Table 1) related to the dry weight of the hardening accelerator.
The standard LC³ mix design with 50 wt.-% of cement were tested. Variation of the LC³ mix design were also tested with 35 and 25 wt.-% of cement in the system. Results are given in Table 2.
3 wt.-% CSH increased the early strength as well as the later strength of the calcined clay system compared to the reference. Meanwhile, the strength of the standard LC³ system with 50 wt.-% cement could compete with the pure OPC when 3 wt.-% CSH was used. Further optimization of the mix design together with the CSH dosage could provide a solution with similar performance as OPC, while use limited OPC in the mix (i.e. 40% OPC).
The ingredients were blended together in the amounts according to Table 1 and the strength according to EN 196-1 was detected after eight hours, 24 hours, seven days, and 28 days. The respective strength is given in Tables 2 (8 h, 24 h, 7d, and 28 d) and 3 (28 d). Examples 0 to 12 comprise CEM I 52.5 R cement.

TABLE 1
Compositions. Comp. denotes “comparative”, INV denote “inventive”. The amounts are given in g.

| Ex. | | | | Calc. | Lime- | | | Quartz | Sum | |
|---|---|---|---|---|---|---|---|---|---|---|
| # | Status | Sand | OPC | Clay | stone | Anhyd. | CSH | powder | Binder | Water |
| 0 | Comp. | 1350 | 450 | | | | | | 450 | 225 |
| 1 | Comp. | 1350 | 225 | 135 | 67.5 | 22.5 | | | 450 | 225 |
| 2 | INV | 1350 | 225 | 135 | 67.5 | 22.5 | 6.75 | | 456.75 | 225 |
| 3 | INV | 1350 | 225 | 135 | 67.5 | 22.5 | 13.5 | | 463.5 | 225 |
| 4 | Comp. | 1350 | 225 | 135 | | | 13.5 | 157.5 | 373.5 | 225 |
| 5 | Comp. | 1350 | 157.5 | 135 | 135 | 22.5 | | | 450 | 225 |
| 6 | INV | 1350 | 157.5 | 135 | 135 | 22.5 | 6.75 | | 456.75 | 225 |
| 7 | INV | 1350 | 157.5 | 135 | 135 | 22.5 | 13.5 | | 463.5 | 225 |
| 8 | Comp. | 1350 | 157.5 | 135 | | | 13.5 | 157.5 | 306 | 225 |
| 9 | Comp. | 1350 | 112.5 | 202.5 | 101.25 | 33.75 | | | 450 | 225 |
| 10 | INV | 1350 | 112.5 | 202.5 | 101.25 | 33.75 | 6.75 | | 456.75 | 225 |
| 11 | INV | 1350 | 112.5 | 202.5 | 101.25 | 33.75 | 13.5 | | 463.5 | 225 |
| 12 | Comp. | 1350 | 112.5 | 202.5 | | | 13.5 | 135 | 328.5 | 225 |

TABLE 2
Early and later strengths of the respective compositions. The strength values are
given in MPa. Comp. denotes “comparative”, INV denote “inventive”. CI.* denotes “Strength
class according to EN 197-1:2011”.

| Ex. | | | Calc. | Lime- | | | | | | | |
|---|---|---|---|---|---|---|---|---|---|---|---|
| # | Status | OPC | Clay | stone | Anhyd. | CSH | 8 h | 24 h | 7 d | 28 d | CI.* |
| 0 | Comp. | 100% | 0% | 0% | 0% | 0% | 4.5 | 31.0 | 51.5 | 61.3 | |
| 1 | Comp. | 50% | 30% | 15% | 5% | 0% | 3.9 | 17.7 | 40.5 | 51.4 | |
| 2 | INV | 49% | 30% | 15% | 5% | 1% | 7.8 | 21.0 | 47.4 | 59.1 | 52.5N |
| 3 | INV | 49% | 29% | 15% | 5% | 3% | 13.8 | 24.7 | 53.8 | 68.9 | 52.5R |
| 4 | Comp. | 60% | 36% | 0% | 0% | 4% | 8.4 | 19.5 | 41.1 | 58.0 | |
| 5 | Comp. | 35% | 30% | 30% | 5% | 0% | 1.7 | 10.4 | 29.2 | 35.0 | |
| 6 | INV | 34% | 30% | 30% | 5% | 1% | 3.8 | 12.3 | 35.4 | 38.9 | 32.5R |
| 7 | INV | 34% | 29% | 29% | 5% | 3% | 6.7 | 15.7 | 40.1 | 53.4 | 52.5N |
| 8 | Comp. | 51% | 44% | 0% | 0% | 4% | 4.2 | 10.7 | 25.4 | 44.3 | |
| 9 | Comp. | 25% | 45% | 23% | 8% | 0% | 1.7 | 10.1 | 24.0 | 30.6 | |
| 10 | INV | 25% | 44% | 22% | 7% | 1% | 2.6 | 11.5 | 23.8 | 32.6 | 32.5R |
| 11 | INV | 24% | 44% | 22% | 7% | 3% | 4.5 | 14.0 | 36.2 | 40.6 | 32.5R |
| 12 | Comp. | 34% | 62% | 0% | 0% | 4% | 2.4 | 7.0 | 20.9 | 33.9 | |

TABLE 3
Ingredient ratios. Comp. denotes “comparative”, INV
denote “inventive”. The strength values are given in MPa.

| | | | OPC/ | OPC/ | | | |
|---|---|---|---|---|---|---|---|
| Ex. | | | Calc. | Lime- | OPC/ | OPC/ | |
| # | Status | OPC | Clay | stone | Anhydrite | CSH | 28 d |
| 0 | Comp. | 1.00 | — | — | — | — | 61.3 |
| 1 | Comp. | 1.00 | 1 ⅔ | 3 ⅓ | 10 | — | 51.4 |
| 2 | INV | 1.00 | 1 ⅔ | 3 ⅓ | 10 | 33 ⅓ | 59.1 |
| 3 | INV | 1.00 | 1 ⅔ | 3 ⅓ | 10 | 16 ⅔ | 68.9 |
| 4 | Comp. | 1.00 | 1 ⅔ | — | — | 16 ⅔ | 58.0 |
| 5 | Comp. | 1.00 | 1 ⅙ | 1 ⅙ | 7 | — | 35.0 |
| 6 | INV | 1.00 | 1 ⅙ | 1 ⅙ | 7 | 23 ⅓ | 38.9 |
| 7 | INV | 1.00 | 1 ⅙ | 1 ⅙ | 7 | 11 ⅔ | 53.4 |
| 8 | Comp. | 1.00 | 1 ⅙ | — | — | 11 ⅔ | 44.3 |
| 9 | Comp. | 1.00 | 5/9 | 1 1/9 | 3 ⅓ | — | 30.6 |
| 10 | INV | 1.00 | 5/9 | 1 1/9 | 3 ⅓ | 16 ⅔ | 32.6 |
| 11 | INV | 1.00 | 5/9 | 1 1/9 | 3 ⅓ | 8 ⅓ | 40.6 |
| 12 | Comp. | 1.00 | 5/9 | — | — | 8 ⅓ | 33.9 |

As can be seen from the examples, the inventive systems, comprising at least a Portland cement clinker, a supplementary cementitious material, a calcium carbonate phase, and a hardening accelerator A not only provide for a high early strength but also an improved or comparable later strength.
Additionally, cements comprising CEM I 42.5 N were tested. The ingredients were blended together in the percentage ratio according to Tables 4 to 6, 8 , 9 and 10. The respective strength according to EN 196-1 was detected after 24 hours, two days, seven days, and 28 days (given in Tables 4, 5, 7, 8, 9 and 11).

TABLE 4
Early and later strengths of the respective compositions. The strength values are
given in MPa. Comp. denotes “comparative”, INV denote “inventive”. The total solid sums
up to 100%. CI.* denotes “Strength class according to EN 197-1:2011”.

| Ex. | | | Calc. | Lime- | | | | | | |
|---|---|---|---|---|---|---|---|---|---|---|
| # | Status | OPC | Clay | stone | Anhyd. | CSH | 24 h | 7 d | 28 d | CI.* |
| 13 | Comp. | 100.00 | | | | | 6.8 | 29.2 | 43.6 | |
| 14 | Comp. | 97.09 | | | | 2.91 | 18.1 | 42.3 | 54.2 | |
| 15 | Comp. | 55.00 | 30.00 | 15.00 | | | 3.0 | 23.8 | 43.9 | |
| 16 | Comp. | 53.40 | 29.13 | 14.56 | | 2.91 | 7.9 | 35.3 | 59.2 | |
| 17 | Comp. | 40.00 | 30.00 | 30.00 | | | 1.7 | 15.8 | 30.4 | |
| 18 | Comp. | 38.83 | 29.13 | 29.13 | | 2.91 | 4.5 | 25.6 | 41.0 | |
| 19 | Comp. | 30.00 | 30.00 | 40.00 | | | 1.4 | 13.3 | 20.2 | |
| 20 | Comp. | 29.13 | 29.13 | 38.83 | | 2.91 | 3.8 | 21.9 | 30.6 | |
| 21 | Comp. | 50.00 | 30.00 | 15.00 | 5.00 | | 5.3 | 27.6 | 40.1 | |
| 22 | INV | 48.54 | 29.13 | 14.56 | 4.85 | 2.91 | 9.4 | 37.7 | 53.7 | 52.5L |
| 23 | Comp. | 35.00 | 30.00 | 30.00 | 5.00 | | 3.1 | 20.8 | 27.5 | |
| 24 | INV | 34.65 | 29.70 | 29.70 | 4.95 | 0.99 | 3.9 | 22.1 | 28.6 | |
| 25 | INV | 34.31 | 29.41 | 29.41 | 4.90 | 1.96 | 5.3 | 23.9 | 34.6 | 32.5N |
| 26 | INV | 33.98 | 29.13 | 29.13 | 4.85 | 2.91 | 5.8 | 27.4 | 36.3 | 32.5N |
| 27 | INV | 33.33 | 28.57 | 28.57 | 4.76 | 4.76 | 6.2 | 27.9 | 38.5 | 32.5N |
| 28 | Comp. | 25.00 | 30.00 | 40.00 | 5.00 | | 2.4 | 13.2 | 16.5 | |
| 29 | INV | 24.27 | 29.13 | 38.83 | 4.85 | 2.91 | 4.7 | 18.8 | 25.3 | |

TABLE 5
Early and later strengths of the respective compositions. The strength values are
given in MPa. Comp. denotes “comparative”, INV denote “inventive”. The total solid sums
up to 100%. CI.* denotes “Strength class according to EN 197-1:2011”.

| Ex. | | | Calc. | Lime- | | | | 24 | | 28 | |
|---|---|---|---|---|---|---|---|---|---|---|---|
| # | Status | OPC | Clay | stone | Anhyd. | Gypsum | CSH | h | 7 d | d | CI.* |
| 30 | Comp. | 54.00 | 30.00 | 15.00 | 1.00 | | | 3.9 | 26.5 | 43.0 | |
| 31 | INV | 52.43 | 29.13 | 14.56 | 0.97 | | 2.91 | 8.5 | 37.4 | 55.3 | 52.5L |
| 32 | Comp. | 53.00 | 30.00 | 15.00 | 2.00 | | | 5.2 | 27.6 | 44.9 | |
| 33 | INV | 51.46 | 29.13 | 14.56 | 1.94 | | 2.91 | 9.8 | 37.7 | 54.6 | 52.5L |
| 34 | Comp. | 47.00 | 30.00 | 15.00 | 8.00 | | | 3.8 | 27.3 | 38.5 | |
| 35 | INV | 45.63 | 29.13 | 14.56 | 7.77 | | 2.91 | 7.1 | 32.0 | 43.3 | 42.5N |
| 36 | Comp. | 45.00 | 30.00 | 15.00 | 10.00 | | | 3.1 | 26.6 | 36.2 | |
| 37 | INV | 43.69 | 29.13 | 14.56 | 9.71 | | 2.91 | 6.5 | 30.9 | 43.0 | 42.5N |
| 38 | Comp. | 53.00 | 30.00 | 15.00 | | 2.00 | | 4.2 | 25.1 | 42.9 | |
| 39 | INV | 51.46 | 29.13 | 14.56 | | 1.94 | 2.91 | 9.0 | 36.7 | 54.5 | 52.5L |
| 40 | Comp. | 50.00 | 30.00 | 15.00 | | 5.00 | | 5.1 | 25.4 | 38.7 | |
| 41 | INV | 48.54 | 29.13 | 14.56 | | 4.85 | 2.91 | 9.0 | 35.5 | 53.5 | 52.5L |

TABLE 6
Early and later strengths of the respective compositions. The strength values are
given in MPa. Comp. denotes “comparative”, INV denote “inventive”. The total solid sums
up to 100%.

| | | | Calc. | Lime- | | Fly | | Micro | |
|---|---|---|---|---|---|---|---|---|---|
| Ex. # | Status | OPC | Clay | stone | Anhyd. | ash | Slag | Silica | CSH |
| 42 | Comp. | 52.00 | 20.00 | 15.00 | 3.00 | | | 10.00 | |
| 43 | INV | 50.49 | 19.42 | 14.56 | 2.91 | | | 9.71 | 2.91 |
| 44 | Comp. | 52.00 | 20.00 | 15.00 | 3.00 | 10.00 | | | |
| 45 | INV | 50.49 | 19.42 | 14.56 | 2.91 | 9.71 | | | 2.91 |
| 46 | Comp. | 52.00 | 20.00 | 15.00 | 3.00 | | 10.00 | | |
| 47 | INV | 50.49 | 19.42 | 14.56 | 2.91 | | 9.71 | | 2.91 |
| 48 | Comp. | 55.00 | 20.00 | 15.00 | | | | 10.00 | |
| 49 | INV | 53.40 | 19.42 | 14.56 | | | | 9.71 | 2.91 |
| 50 | Comp. | 55.00 | 20.00 | 15.00 | | 10.00 | | | |
| 51 | INV | 53.40 | 19.42 | 14.56 | | 9.71 | | | 2.91 |
| 52 | Comp. | 55.00 | 20.00 | 15.00 | | | 10.00 | | |
| 53 | INV | 53.40 | 19.42 | 14.56 | | | 9.71 | | 2.91 |

TABLE 7
Early and later strengths of the respective compositions.
The strength values are given in MPa. Comp. denotes
“comparative”, INV denote “inventive”.

| | | | | | Strength class |
|---|---|---|---|---|---|
| | | | | | according to |
| Ex. # | Status | 24 h | 7 d | 28 d | EN 197-1: 2011 |
| 42 | Comp. | 6.4 | 26.0 | 41.6 | |
| 43 | INV | 8.9 | 33.2 | 53.0 | 52.5L |
| 44 | Comp. | 4.0 | 19.8 | 34.7 | |
| 45 | INV | 7.3 | 26.8 | 46.2 | 42.5N |
| 46 | Comp. | 4.8 | 22.9 | 41.1 | |
| 47 | INV | 8.4 | 33.9 | 51.6 | 42.5N |
| 48 | Comp. | 4.0 | 27.1 | 44.9 | |
| 49 | INV | 7.9 | 35.3 | 56.3 | 52.5L |
| 50 | Comp. | 2.7 | 19.7 | 35.5 | |
| 51 | INV | 7.2 | 29.9 | 47.2 | 42.5N |
| 52 | Comp. | 2.9 | 23.5 | 42.2 | |
| 53 | INV | 7.9 | 38.2 | 55.2 | 52.5L |

TABLE 8
Early and later strengths of the respective compositions. The strength values are
given in MPa. Comp. denotes “comparative”, INV denote “inventive”. The total solid sums
up to 100%. CI.* denotes “Strength class according to EN 197-1:2011”.

| Ex. | | | Calc. | Lime- | | | | | | |
|---|---|---|---|---|---|---|---|---|---|---|
| # | Status | OPC | Clay | stone | Anhyd. | Quarz | CSH | 24 h | 7 d | 28 d |
| 54 | Comp. | 50.00 | | 15.00 | 5.00 | 30.00 | | 2.0 | 7.0 | 9.0 |
| 55 | Comp. | 48.54 | | 14.56 | 4.85 | 29.13 | 2.91 | 4.1 | 7.1 | 9.4 |
| 56 | Comp. | 35.00 | | 30.00 | 5.00 | 30.00 | | 1.0 | 3.3 | 4.4 |
| 57 | Comp. | 33.98 | | 29.13 | 4.85 | 29.13 | 2.91 | 2.1 | 3.7 | 4.9 |
| 58 | Comp. | 25.00 | | 40.00 | 5.00 | 30.00 | | 0.0 | 1.9 | 2.5 |
| 59 | Comp. | 24.27 | | 38.83 | 4.85 | 29.13 | 2.91 | 1.3 | 2.1 | 2.9 |
| 60 | Comp. | | 30.00 | 15.00 | 5.00 | 50.00 | | 0.0 | 0 | 0.0 |
| 61 | Comp. | | 29.13 | 14.56 | 4.85 | 48.54 | 2.91 | 0.0 | 0 | 0.0 |
| 62 | Comp. | | 30.00 | 30.00 | 5.00 | 35.00 | | 0.0 | 0 | 0.0 |
| 63 | Comp. | | 29.13 | 29.13 | 4.85 | 33.98 | 2.91 | 0.0 | 0 | 0.0 |
| 64 | Comp. | | 30.00 | 40.00 | 5.00 | 25.00 | | 0.0 | 0 | 0.0 |
| 65 | Comp. | | 29.13 | 38.83 | 4.85 | 24.27 | 2.91 | 0.0 | 0 | 0.0 |

TABLE 9
Early and later strengths of the respective compositions. The strength values are
given in MPa. Comp. denotes “comparative”, INV denote “inventive”. The total solid sums
up to 100%.

| Ex. | | | Calc. | EcoCem_ | | Quarz- | | | | |
|---|---|---|---|---|---|---|---|---|---|---|
| # | Status | OPC | Clay | Slag | Anhyd. | Powder | CSH | 24 h | 7 d | 28 d |
| 66 | Comp. | 50.00 | 30.00 | | 5.00 | 15.00 | | 5.6 | 27.0 | 42.2 |
| 67 | Comp. | 48.54 | 29.13 | | 4.85 | 14.56 | 2.91 | 10.0 | 35.9 | 53.1 |
| 68 | Comp. | 35.00 | 30.00 | | 5.00 | 30.00 | | 2.8 | 18.8 | 28.3 |
| 69 | Comp. | 33.98 | 29.13 | | 4.85 | 29.13 | 2.91 | 5.3 | 22.7 | 34.7 |
| 70 | Comp. | 25.00 | 30.00 | | 5.00 | 40.00 | | 2.3 | 14.2 | 19.3 |
| 71 | Comp. | 24.27 | 29.13 | | 4.85 | 38.83 | 2.91 | 4.8 | 16.9 | 23.4 |
| 72 | Comp. | 40.00 | 30.00 | | | 30.00 | | 2.2 | 13.1 | 30.8 |
| 73 | Comp. | 38.83 | 29.13 | | | 29.13 | 2.91 | 4.4 | 19.0 | 38.6 |
| 74 | Comp. | 50.00 | | 30.00 | 5.00 | 15.00 | | 2.3 | 21.6 | 38.2 |
| 75 | Comp. | 48.54 | | 29.13 | 4.85 | 14.56 | 2.91 | 5.3 | 26.5 | 47.2 |
| 76 | Comp. | 35.00 | | 30.00 | 5.00 | 30.00 | | 1.0 | 17.7 | 31.6 |
| 77 | Comp. | 33.98 | | 29.13 | 4.85 | 29.13 | 2.91 | 3.2 | 20.1 | 38.7 |
| 78 | Comp. | 25.00 | | 30.00 | 5.00 | 40.00 | | | 15.9 | 27.2 |
| 79 | Comp. | 24.27 | | 29.13 | 4.85 | 38.83 | 2.91 | 1.8 | 16.1 | 31.8 |

TABLE 10
Early and later strengths of the respective compositions. The strength
values are given in MPa. Comp. denotes “comparative”,
INV denote “inventive”. The total solid sums up to 100%.

| | | | Calc. | Lime- | | | |
|---|---|---|---|---|---|---|---|
| Ex. # | Status | OPC | Clay | stone | Anhyd. | Slag | CSH |
| 80 | Comp. | 50.00 | 15.00 | 17.00 | 3.00 | 15.00 | |
| 81 | INV | 48.54 | 14.56 | 16.50 | 2.91 | 14.56 | 2.91 |
| 82 | Comp. | 40.00 | 20.00 | 17.00 | 3.00 | 20.00 | |
| 83 | INV | 38.83 | 19.42 | 16.50 | 2.91 | 19.42 | 2.91 |
| 84 | INV | 24.27 | 26.70 | 16.50 | 2.91 | 26.70 | 2.91 |
| 85 | INV | 19.42 | 33.98 | 6.80 | 2.91 | 33.98 | 2.91 |
| 86 | INV | 19.42 | 29.13 | 16.50 | 2.91 | 29.13 | 2.91 |

TABLE 11
Early and later strengths of the respective compositions. The strength values are given in MPa.
Comp. denotes “comparative”, INV denote “inventive”.

| | | | | | | Strength class |
|---|---|---|---|---|---|---|
| Ex. | | | | | | according to EN |
| # | Status | 24 h | 2d | 7 d | 28 d | 197-1:2011 |
| 80 | Comp. | 5.3 | 9.2 | 23.6 | 39.8 | |
| 81 | INV | 9.4 | 15.2 | 34.6 | 51.3 | 42.5N |
| 82 | Comp. | 4.5 | 7.8 | 23.2 | 37.3 | |
| 83 | INV | 9.0 | 15.9 | 33.5 | 50.6 | 42.5N |
| 84 | INV | 7.8 | 14.9 | 30.6 | 44.4 | 42.5N |
| 85 | INV | 10.8 | 18.9 | 33.5 | 45.4 | 42.5N |
| 86 | INV | 8.4 | 14.8 | 26.4 | 37.1 | 32.5L |

As can be seen from the examples 0 to 86, the inventive systems, comprising at least a Portland cement clinker, a supplementary cementitious material, a calcium carbonate phase, and a hardening accelerator A not only provide for a high early strength but also an improved or comparable later strength.
It is noted that even if compressive strengths of Example 67 are comparable to those of Example 22, Example 67 comprises quartz powder. Hence, Example 67 does not avoid ingredients which are non-hazardous according to GHS08. Example 22 however comprises limestone instead of quartz powder and is thus preferred in view safety issues.

Hence, the present invention provides inter alia an environmental friendly composition. The comparison of e.g. Comparative Examples 20 and 23 with Inventive Example 26 discloses that the Inventive Example is superior not only in the early but also in the late strength. These compositions all provide a compositions having a low amount of OPC and a rather high amount of limestone, therefore being particular environmental friendly.

1-17. (canceled)

18. A construction material composition comprising
a) Portland cement clinker in an amount of from 15 to 55% by dry weight based on the total dry weight of the construction material composition;
b) a supplementary cementitious material in an amount of from 20 to 75% by dry weight based on the total dry weight of the construction material composition;
c) a calcium carbonate phase in an amount of from 5 to 40% by dry weight based on the total dry weight of the construction material composition;
d) a sulfate source selected from the group consisting of gypsum, bassanite, anhydrite, and mixtures thereof in an amount of from more than 2.2 to 8 wt.-% of SO₃ based on the total dry weight of the construction material composition; and
e) a hardening accelerator A comprising particles with calcium and silicon in a molar ratio Ca/Si of 0.1 to 2.2 in an amount of from 0.1 to 5% by weight related to the weight of the sum of CaO and SiO₂ of the hardening accelerator A based on the total dry weight of the construction material composition.

19. The construction material composition according to claim 18, wherein the supplementary cementitious material is selected from the group consisting of slag, fly ash, natural pozzolans, calcinated clay, silica fume, and mixtures thereof and/or wherein the calcium carbonate phase is selected from limestone, dolomite, calcite, aragonite, vaterite, and mixtures thereof.

20. The construction material composition according to claim 18, wherein the total SO₃ content and the total Al₂O₃ content determined by elemental analysis are present in a weight ratio of from 1:10 to 5:1.

21. The construction material composition according to claim 18, wherein the Portland cement clinker and the supplementary cementitious material are present in a weight ratio of from 2:1 to 1:5.

22. The construction material composition according to claim 18, wherein the Portland cement clinker and the limestone are present in a weight ratio of from 4:1 to 1:2.

23. The construction material composition according to claim 18, wherein the hardening accelerator A further comprises a water soluble polymer in an amount of from 0.1% to 50% by weight related to the dry weight of the hardening accelerator A.

24. The construction material composition according to claim 18, wherein the hardening accelerator A comprises particles which are calcium-silicate-hydrate of the following empirical formula
a CaO, SiO₂, b Al₂O₃, c H₂O, d X, e W
X is an alkali metal
W is an alkaline earth metal
0.5≤a≤2.5
0≤b≤1
1≤c≤6
0≤d≤1
0≤e≤2.

25. The construction material composition according to claim 18, wherein the composition comprises
a) the Portland cement clinker in an amount of from 40 to 55% by dry weight based on the total dry weight of the construction material composition;
b) the supplementary cementitious material in an amount of from 30 to 45% by dry weight based on the total dry weight of the construction material composition;
c) the calcium carbonate phase in an amount of from 15 to 30% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.1 to 5% by weight related to the weight of the sum of CaO and SiO₂ of the hardening accelerator A based on the total dry weight of the construction material composition.

26. The construction material composition according to claim 18, wherein the composition comprises
a) the Portland cement clinker in an amount of from 30 to 40% by dry weight based on the total dry weight of the construction material composition;
b) the supplementary cementitious material in an amount of from 30 to 45% by dry weight based on the total dry weight of the construction material composition;
c) the calcium carbonate phase in an amount of from 20 to 30% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.5 to 5% by weight related to the weight of the sum of CaO and SiO₂ of the hardening accelerator A based on the total dry weight of the construction material composition.

27. The construction material composition according to claim 18, wherein the composition comprises
a) Portland cement clinker in an amount of from 20 to 30% by dry weight based on the total dry weight of the construction material composition;
b) the supplementary cementitious material in an amount of from 30 to 50% by dry weight based on the total dry weight of the construction material composition;
c) the calcium carbonate phase in an amount of from 20 to 40% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 1.0 to 5% by weight related to the weight of the sum of CaO and SiO₂ of the hardening accelerator A based on the total dry weight of the construction material composition.

28. The construction material composition according to claim 18, wherein the construction material composition comprises from more than 30 to 75% by dry weight of the supplementary cementitious material, based on the total dry weight of the construction material composition.

29. The construction material composition according to claim 18, wherein the construction material composition comprises
a) the Portland cement clinker in an amount of from 15 to 47% by dry weight based on the total dry weight of the construction material composition;
b) the supplementary cementitious material in an amount of from more than 30 to 70% by dry weight based on the total dry weight of the construction material composition;
c) the calcium carbonate phase in an amount of from 5 to 20% by dry weight based on the total dry weight of the construction material composition;
d) the sulfate source in an amount of from 2.5 to 7 wt.-% of SO₃ based on the total dry weight of the construction material composition; and
e) the hardening accelerator A in an amount of from 0.1 to 5% by weight related to the weight of the sum of CaO and SiO₂ of the hardening accelerator A based on the total dry weight of the construction material composition.

30. The construction material composition according to claim 18, additionally comprising at least one additive selected from the group consisting of inorganic carbonates, alkali metal sulfates, polymeric dispersants, hardening accelerators, hardening retarders, thickeners, and stabilizers or a mixture of two or more thereof and/or
additionally comprising at least one polymeric dispersant, in particular a polycarboxylate ether, phosphorylated polycondensation product or a sulfonic acid and/or sulfonate group containing dispersant and/or
additionally comprising at least one polymeric dispersant, which is a sulfonic acid and/or sulfonate group containing dispersant selected from the group consisting of lignosulfonates, melamine formaldehyde sulfonate condensates, beta-naphthalene sulfonic acid condensates, sulfonated ketone-formaldehyde-condensates, and copolymers comprising sulfo group containing units and/or sulfonate group-containing units and carboxylic acid and/or carboxylate group-containing units and/or
additionally comprising at least one hardening accelerator B.

31. Use of a hardening accelerator A comprising particles with calcium and silicon in a molar ratio Ca/Si of 0.1 to 2.2 in a construction material composition comprising at most 55% by dry weight of Portland cement clinker based on the total dry weight of the construction material composition, wherein the hardening accelerator A is present in the construction material composition in an amount of from 0.1 to 5% by weight related to the weight of the sum of CaO and SiO₂ of the hardening accelerator A based on the total dry weight of the construction material composition.

32. Use according to claim 31, wherein the construction material composition comprises
a) Portland cement clinker in an amount of from 15 to 55% by dry weight based on the total dry weight of the construction material composition;
b) a supplementary cementitious material in an amount of from 20 to 75% by dry weight based on the total dry weight of the construction material composition;
c) a calcium carbonate phase in an amount of from 5 to 40% by dry weight based on the total dry weight of the construction material composition;
d) a sulfate source selected from the group consisting of gypsum, bassanite, anhydrite, and mixtures thereof in an amount of from more than 2.2 to 8 wt.-% of SO₃ based on the total dry weight of the construction material composition; and
e) a hardening accelerator A comprising particles with calcium and silicon in a molar ratio Ca/Si of 0.1 to 2.2 in an amount of from 0.1 to 5% by weight related to the weight of the sum of CaO and SiO₂ of the hardening accelerator A based on the total dry weight of the construction material composition.

33. A mortar or concrete comprising a construction material composition according to claim 18.

34. A process for producing a construction material composition according to claim 18, wherein the calcium carbonate phase is provided as a powder and the hardening accelerator A is provided as a suspension.
